(19) United States
(12) Patent Application Publication
(10) Pub. No.: US 2017/0056974 A1
(43) Pub. Date: Mar. 2, 2017

(54) THREE-DIMENSIONAL FORMING DEVICE, THREE-DIMENSIONAL FORMING METHOD, AND THREE-DIMENSIONAL FORMED ARTICLE

(71) Applicant: SEIKO EPSON CORPORATION, Tokyo (JP)

(72) Inventors: Takeshi MIYASHITA, Suwa-shi (JP); Hajime ONISHI, Chino-shi (JP); Toshihiro OTAKE, Chino-shi (JP); Tomoyuki KAMAKURA, Matsumoto-shi (JP)

(21) Appl. No.: 15/243,437

(22) Filed: Aug. 22, 2016

(30) Foreign Application Priority Data
Aug. 26, 2015 (JP) 2015-166484

(51) Int. Cl. B22F 3/105; B33Y 30/00; B22F 1/00; B33Y 50/02; B22F 3/10; B33Y 10/00; B33Y 80/00

(52) U.S. Cl. CPC B22F 3/1055; B33Y 10/00; B33Y 30/00; B33Y 80/00; B33Y 50/02; B22F 3/1021; B22F 1/0059; B22F 2003/1057; B22F 2998/10

(57) ABSTRACT

A three-dimensional forming device is a three-dimensional forming device which forms a three-dimensional formed article by stacking a layer using a sintering material containing a metal powder, a binder, and a solvent, and includes a material supply section which supplies the sintering material to a predetermined material supply region, a first heating section which heats the predetermined material supply region, a second heating section which heats the sintering material supplied to the predetermined material supply region from the material supply section, and an energy irradiation section which supplies energy for sintering the metal powder.

### BACKGROUND

1. Technical Field

The present invention relates to a three-dimensional forming device, a three-dimensional forming method, and a three-dimensional formed article.

2. Related Art

In the related art, as a forming method for simply forming a three-dimensional shape using a metal material, a method as described in JP-A-2008-184622 (PTL 1) has been disclosed. In the forming method for a three-dimensional formed article disclosed in PTL 1, as a raw material, a metal paste containing a metal powder, a solvent, and an adhesion enhancer is used and formed into a material layer in the form of a layer. Then, the material layer in the form of a layer is irradiated with a light beam, thereby forming a metal sintered layer or a metal fused layer, and by repeating the formation of a material layer and the irradiation with a light beam, the sintered layer or the fused layer is stacked, whereby a desired three-dimensional formed article is obtained.

However, in the forming method for a three-dimensional formed article described in PTL 1, only part of the material layer supplied in the form of a layer is sintered or fused by irradiation with a light beam and is formed as part of a three-dimensional formed article, and the material layer which is not irradiated with a light beam is a wasteful portion which is only removed. Further, there is a problem that, with respect to the predetermined region irradiated with the light beam, a material layer which is, although incompletely, sintered or fused is generated also in the vicinity thereof, and the incomplete portion adheres to a desired portion formed by sintering or fusing, and therefore, the shape of the three-dimensional formed article is unstable.

In view of this, it can be conceived that the problem of PTL 1 is solved by applying a nozzle capable of forming a metal-overlaid portion by irradiating a desired place with a laser while supplying a powder metal material thereto disclosed in JP-A-2005-219060 (PTL 2) or JP-A-2013-75308 (PTL 3).

The nozzle disclosed in PTL 2 or PTL 3 includes a laser irradiation part in the center of the nozzle, and also includes a powder supply part which supplies a metal powder (powder) to the surroundings of the laser irradiation part. Then, the powder is supplied to the laser irradiated from the laser irradiation part in the center of the nozzle, and the supplied powder is fused by the laser and formed as an overlaid metal on a processing target.

Further, in the forming method for a three-dimensional formed article described in PTL 1, in one layer of the material layers to be stacked to constitute the three-dimensional formed article, the light beam scans using a galvanometer mirror along the irradiation path of the light beam obtained from three-dimensional CAD data or the like, and the material layer is fused and solidified, whereby a desired sintered layer can be obtained. Further, in a forming method for a three-dimensional formed article described in U.S. Patent Application Publication No. 2014/0175706 (PTL 4), it is disclosed that a raw material is placed by making the dropping position of the raw material different between a first layer and a second layer and between a second layer and a third layer.

However, in the case where the overlaid metal is formed using the nozzle disclosed in PTL 2 or PTL 3, it is difficult to make the particle diameter of the metal powder to be applied smaller. That is, adhesiveness between particles is increased by making the particle diameter very small, that is, by forming a fine powder, and thus, the powder becomes a so-called highly adhesive powder. Therefore, for example, when the powder is conveyed and ejected by compressed air or the like, the powder is easily adhered to a flow path, and thus, the fluidity is significantly deteriorated, and the ejection stability is deteriorated. Accordingly, in order to ensure the fluidity of the powder, there is a limitation on the reduction in the particle diameter of the powder, and it is difficult to use the nozzle disclosed in PTL 2 or PTL 3 for the formation of a three-dimensional shape minutely with high precision which cannot be realized unless a powder with a very small particle diameter is used.

Further, in the forming method for a three-dimensional formed article disclosed in PTL 1, in order to improve the productivity, it is demanded that the fusion and solidification width of the material layer in the direction crossing the scanning direction of the light beam be increased or the scanning speed be increased. On the other hand, in the case where a minute forming region is included in the three-dimensional formed article, by decreasing the fusion and solidification width or decreasing the scanning speed, a minute three-dimensional formed article can be obtained.

Further, in the forming method for a three-dimensional formed article disclosed in PTL 4, it is proposed that in order to correct the incomplete dot ejection position, the second layer is ejected in a different place from the first layer, or in order to correct the height after the first layer is formed and shrunk, correction is added to the ejection position, however, a method for maximizing the efficiency and enabling material supply is not presented.

In this manner, the improvement of the productivity of a three-dimensional formed article and the improvement of the forming precision of a minute shape portion include contradictory factors. However, in the production method for a three-dimensional formed article disclosed in PTL 1, in order to realize the improvement of the productivity and the improvement of the forming precision, for example, it is necessary to include a plurality of light beam irradiation sections so that a light beam capable of forming a wide fusion and solidification width and a light beam for precision formation can be irradiated, which leads to an increase in the size of the device or an increase in the cost of the device.

### SUMMARY

An advantage of some aspects of the invention is to obtain a three-dimensional forming device and a three-dimensional forming method capable of using a metal powder with a very small particle diameter so that a minute three-dimensional formed article can be formed, and also to obtain a three-dimensional formed article capable of obtaining high productivity by increasing the fusion and solidification width by an energy beam irradiated from a single energy beam irradiation section, and also capable of realizing the formation of a minute shape with high precision, and to obtain a formation method for the three-dimensional formed article.

The invention can be implemented as the following aspects or application examples.

### APPLICATION EXAMPLE 1

A three-dimensional forming device according to this application example is a three-dimensional forming device, which forms a three-dimensional formed article by stacking a layer using a sintering material containing a metal powder, a binder, and a solvent, and includes a material supply section which supplies the sintering material to a predetermined material supply region, a first heating section which heats the predetermined material supply region, a second heating section which heats the sintering material supplied to the predetermined material supply region from the material supply section, and an energy irradiation section which supplies energy for sintering the metal powder.

By using the three-dimensional forming device according to this application example, a necessary amount of the sintering material is supplied to a region where the shape of a three-dimensional formed article to be formed is formed, and energy is supplied by the energy irradiation section to the supplied sintering material, and therefore, the material supply loss and supply energy loss are reduced.

In the related art, an adhesive force between metal fine particles which occurs when only a metal powder is supplied and sintered is increased and thus, the powder becomes a highly adhesive powder, and when the powder is conveyed and ejected by compressed air or the like, the powder is easily adhered to a flow path, resulting in significant deterioration of the fluidity in some cases, and therefore, there is a limitation on the reduction in the particle diameter of the metal fine particles. However, by adopting a configuration in which a sintering material containing a metal powder, a binder, and a solvent is supplied onto a predetermined material supply region from a material supply section, the adhesion to the flow path for conveying the material can be prevented, and the material can be stably supplied, and thus, a three-dimensional formed article can be formed using an extremely fine metal powder.

By including a drying section capable of evaporating a liquid component such as the solvent contained in the sintering material in advance before sintering, it is possible to prevent the scattering of the metal powder by evaporating the liquid component in an extremely short time, that is, explosive vaporization or flash boiling by large energy for sintering the sintering material irradiated from the energy irradiation section, and thus, a three-dimensional formed article free of defects can be obtained.

As the drying section, the first heating section and the second heating section are included in the three-dimensional forming device according to this application example. Then, by heating the predetermined material supply region to which the sintering material containing a metal powder, a binder, and a solvent is supplied by the first heating section, when the sintering material is supplied to the predetermined material supply region, the solvent contained in the sintering material is evaporated by the heat supplied to the predetermined material supply region, and the drying of the sintering material is started. According to this, the fluidity of the sintering material is partially decreased, that is, the viscosity is increased, so that the diffusion of the sintering material in the predetermined material supply region can be suppressed, and thus, the material can be accurately placed in a desired shape.

Further, by heating the sintering material supplied to the predetermined material supply region by the second heating section, the solvent remaining in the sintering material which is supplied to the predetermined material supply region heated by the first heating section and partially dried can be further evaporated. According to this, the solvent as a liquid component can be more reliably removed from the sintering material before energy is supplied from the energy irradiation section for sintering the metal powder contained in the supplied sintering material, and thus, the occurrence of flash boiling can be prevented.

Further, by removing the solvent as a liquid component which contributes also to the improvement of the fluidity of the sintering material from the sintering material ejected in the material supply region by the first heating section and the second heating section, the fluidity of the sintering material in the material supply region can be decreased. Therefore, the sintering material can be prevented from diffusing along the surface of the material supply region after the sintering material is ejected, and thus, the three-dimensional forming device capable of forming a precise three-dimensional formed article can be obtained.

Incidentally, in this application example, the term “sintering” refers to a process in which by supplying energy to a sintering material, a solvent which constitutes the sintering material is evaporated by the supplied energy, and then, the remaining metal powder particles are metallically bonded to each other by the supplied energy. In this specification, also a process in which a metal powder is fusion-bonded is regarded as a process in which a metal powder is bonded by supplying energy and described as sintering.

### APPLICATION EXAMPLE 2

In the three-dimensional forming device according to the application example, it is preferred that the material supply section includes an ejection section which ejects the sintering material.

As described above, in the related art, an adhesive force between metal fine particles which occurs when only a metal powder is supplied and sintered is increased and thus, the powder becomes a highly adhesive powder, and when the powder is conveyed and ejected by compressed air or the like, the powder is easily adhered to a flow path, resulting in significant deterioration of the fluidity in some cases, and therefore, there is a limitation on the reduction in the particle diameter of the metal fine particles. However, according to this application example, by adopting a configuration in which a sintering material containing a metal powder, a binder, and a solvent is supplied onto a predetermined material supply region from a material supply section, the adhesion to the flow path for conveying the material can be prevented, and therefore, the material can be stably conveyed and supplied, and moreover, the material can be ejected in the form of a droplet, as a result, an ejection section which supplies a material in a very small amount can be included, and thus, a three-dimensional formed article can be formed using an extremely fine metal powder.

### APPLICATION EXAMPLE 3

In the three-dimensional forming device according to the application example, it is preferred that the predetermined material supply region is a stage, a metal plate, or the layer which is previously formed, the first heating section heats the material supply region to a predetermined temperature before the sintering material is supplied to the material supply region, and the second heating section heats the sintering material supplied to the material supply region to a predetermined temperature.

According to this application example, by heating the predetermined material supply region to which the sintering material is supplied by the first heating section, when the sintering material is supplied to the predetermined material supply region, the solvent contained in the sintering material is evaporated by the heat supplied to the predetermined material supply region, and the drying of the sintering material is started. According to this, the fluidity of the sintering material is partially decreased, that is, the viscosity is increased, so that the diffusion of the sintering material in the predetermined material supply region can be suppressed, and thus, the material can be accurately placed in a desired shape.

Further, by heating the sintering material supplied to the predetermined material supply region by the second heating section, the solvent as a liquid component remaining in the sintering material which is supplied to the predetermined material supply region heated by the first heating section and partially dried can be evaporated. According to this, the solvent as a liquid component can be more reliably removed from the sintering material before energy is supplied from the energy irradiation section for sintering the metal powder contained in the supplied sintering material, and thus, the occurrence of flash boiling can be prevented. Further, at least part of the binder itself can also be thermally decomposed. According to this, the scattering of the metal powder by the generation of a gas as a decomposition component accompanying the rapid thermal decomposition of the binder can be suppressed, and thus, a precise three-dimensional formed article can be formed.

### APPLICATION EXAMPLE 4

In the three-dimensional forming device according to the application example, it is preferred that the device includes a first temperature detection section which detects the temperature of the material supply region to be heated by the first heating section, and a second temperature detection section which detects the temperature of the sintering material to be heated by the second heating section.

There is a fear that the metal powder maybe scattered due to flash boiling by a liquid component, the generation of a thermal decomposition gas, or the like by heating the material supply region to be heated by the first heating section or the sintering material supplied onto the material supply region to be heated by the second heating section to a temperature exceeding the boiling point of a liquid component contained in the sintering material, for example, the solvent or the like contained in the sintering material or the thermal decomposition temperature of the binder. Therefore, according to this application example, flash boiling can be prevented by detecting the temperature of the material supply region or the sintering material supplied to the material supply region by the first and second temperature detection sections, and controlling the operation of the first and second heating sections based on the result.

### APPLICATION EXAMPLE 5

A three-dimensional forming method according to this application example is a three-dimensional forming method for forming a three-dimensional formed article by stacking a layer using a sintering material containing a metal powder and a binder, and includes a material supply step of ejecting the sintering material in the form of a droplet on a first single layer, thereby stacking a unit droplet material, a heating step of heating a material supply region of the unit droplet material on the first single layer, a drying step of drying a unit material formed by the unit droplet material landed on the first single layer, thereby forming a dry sintering material, a sintering step of sintering the dry sintering material by supplying energy for sintering the dry sintering material to the dry sintering material, thereby forming a sintered body, a single layer formation step of forming a sintered single layer by assembling the sintered bodies, and a stacking step of stacking the sintered single layer as the first single layer on the first single layer and forming a second single layer by the single layer formation step, wherein the heating step is performed before the material supply step.

By using the three-dimensional forming method according to this application example, first, the predetermined material supply region to which the sintering material containing a metal powder, a binder, and a solvent is supplied is heated in the heating step before the material supply step, and then, the sintering material is supplied to the heated predetermined material supply region, whereby the solvent contained in the sintering material is evaporated by the heat supplied to the predetermined material supply region, and the drying of the sintering material is started. According to this, the fluidity of the sintering material is partially decreased, that is, the viscosity is increased, so that the diffusion of the sintering material in the predetermined material supply region can be suppressed, and thus, the material can be accurately placed in a desired shape.

Subsequently, by including the drying step after the material supply step, the sintering material supplied to the predetermined material supply region can be heated and dried. According to this, the solvent as a liquid component can be removed from the sintering material before energy is supplied from the energy irradiation section for sintering the metal powder contained in the supplied sintering material, and thus, the occurrence of flash boiling can be prevented. Further, at least part of the binder itself may be thermally decomposed. According to this, the scattering of the metal powder by the generation of a gas as a decomposition component accompanying the thermal decomposition of the binder can be suppressed, and thus, a precise three-dimensional formed article can be obtained.

Further, by removing the solvent as a liquid component which contributes to the improvement of the fluidity of the sintering material from the sintering material ejected in the material supply region by the heating step and the drying step, the fluidity of the sintering material in the material supply region can be decreased. Therefore, the sintering material can be prevented from diffusing along the surface of the material supply region after the sintering material is ejected, and thus, the three-dimensional forming method capable of forming a precise three-dimensional formed article can be obtained.

### APPLICATION EXAMPLE 6

In the three-dimensional forming method according to the application example, it is preferred that when a unit material diameter in plan view of the unit material is represented by Dm and a distance between the unit material centers of the unit materials adjacent to each other is represented by Pm, the following relationship is satisfied: 0.5≦Pm/Dm <1.0.

The three-dimensional forming method according to this application example is a method for obtaining a three-dimensional formed article by stacking a sintered single layer of a metal formed article obtained by sintering the metal powder by irradiation with an energy beam. The sintered single layer is formed as an assembly of a plurality of sintered bodies. The sintered single layer obtained in this manner is formed while satisfying the following relationship: 0.5≦Pm/Dm<1.0 when a unit material diameter in plan view of a unit material as a raw material for forming a sintered body by irradiation with an energy beam is represented by Dm and a distance between the centers of unit materials adjacent to each other is represented by Pm.

According to this application example, in the above relationship, by bringing Pm closer to Dm, that is, by bringing the value of Pm/Dm close to 1.0, the unit materials to be formed into adjacent sintered bodies are placed apart from each other. Therefore, the sintered single layer can be formed in a short time, and thus, the productivity can be increased. Further, by bringing the value of Pm/Dm close to 0.5, the unit materials to be formed into adjacent sintered bodies are placed in proximity to each other, that is, so as to increase an overlapped region, and therefore, the adjacent unit materials are densely placed, so that the sintered single layer in which the sintered bodies obtained by sintering the thus placed unit materials are densely assembled can be formed, and thus, precise formation can be achieved.

### APPLICATION EXAMPLE 7

In the three-dimensional forming method according to the application example, it is preferred that the sintered single layer includes a first sintered body, a second sintered body, and a third sintered body, which are adjacent to one another, and in the second single layer, the unit material center of the unit material forming the sintered body included in the second single layer overlaps with a triangular region in plan view formed by connecting the respective sintered body centers of the first sintered body, the second sintered body, and the third sintered body included in the first single layer.

In Application Example 6, when the unit materials to be formed into the first, second, and third sintered bodies which are adjacent to one another in the first single layer are placed such that the distance between the respective unit material centers (Pm) is close to the value of Dm, a missing part of the sintered body may occur between the adjacent sintered bodies formed by sintering. However, according to this application example, the unit materials to be formed into the sintered bodies included in the second single layer are placed such that the unit material center overlaps in a region in plan view of a triangular region formed by connecting the respective sintered body centers of the first, second, and third sintered bodies adjacent one another included in the sintered single layer of the first single layer as the lower layer, and therefore, the missing part of the sintered body occurring in the first single layer can be filled by irradiation with an energy beam for forming the sintered body of the second single layer. According to this, a three-dimensional formed article can be obtained while removing a missing part of the sintered body, in other words, a region which can become a defective part inside the three-dimensional formed article.

### APPLICATION EXAMPLE 8

A three-dimensional formed article according to this application example is a three-dimensional formed article, which is obtained by stacking, on a first single layer including a sintered single layer obtained by stacking a layer using a sintering material containing a metal powder and a binder, and irradiating an energy beam for sintering the sintering material, a second single layer including at least the sintered single layer, wherein the sintered single layer is formed by assembling sintered bodies obtained by sintering by irradiating the sintering material ejected in the form of a droplet with the energy beam, and when a sintered body diameter in plan view of the sintered body is represented by Ds and a distance between the sintered body centers of the sintered bodies adjacent to each other is represented by Ps, the following relationship is satisfied: 0.5≦Ps/Ds<1.0.

The three-dimensional formed article is obtained by stacking a sintered single layer of a metal formed article obtained by sintering the metal powder by irradiation with an energy beam. The sintered single layer is formed as an assembly of a plurality of sintered bodies. The sintered single layer obtained in this manner is formed while satisfying the following relationship: 0.5≦Ps/Ds<1.0 when a sintered body diameter in plan view of the sintered body is represented by Ds and a distance between the sintered body centers of the sintered bodies adjacent to each other is represented by Ps.

According to this application example, in the above relationship, by bringing Ps closer to Ds, that is, by bringing the value of Ps/Ds close to 1.0, the adjacent sintered bodies are placed apart from each other. Therefore, the sintered single layer can be formed in a short time, and thus, the productivity can be increased. Further, by bringing the value of Ps/Ds close to 0.5, the adjacent sintered bodies are placed in proximity to each other, that is, so as to increase an overlapped region, and therefore, the sintered single layer in which the adjacent sintered bodies are densely assembled can be formed, and thus, precise formation can be achieved.

### APPLICATION EXAMPLE 9

In the three-dimensional formed article according to the application example, it is preferred that the sintered single layer includes a first sintered body, a second sintered body, and a third sintered body, which are adjacent to one another, and the second single layer is placed such that the sintered body center of the sintered body included in the second single layer overlaps with a triangular region in plan view formed by connecting the respective sintered body centers of the first sintered body, the second sintered body, and the third sintered body included in the first single layer.

In Application Example 8, when the first, second, and third sintered bodies which are adjacent to one another in the first single layer are placed such that the distance between the respective sintered body centers (Ps) is close to the value of Ds, a missing part of the sintered body may occur between the adjacent sintered bodies. However, according to this application example, the sintered bodies included in the second single layer are placed such that the sintered body center overlaps in a region in plan view of a triangular region formed by connecting the respective sintered body centers of the first, second, and third sintered bodies adjacent one another included in the sintered single layer of the first single layer as the lower layer, and therefore, the missing part of the sintered body occurring in the first single layer can be filled by irradiation with an energy beam for forming the sintered body of the second single layer. According to this, a three-dimensional formed article can be obtained while removing a missing part of the sintered body, in other words, a region which can become a defective part inside the three-dimensional formed article.

### BRIEF DESCRIPTION OF THE DRAWINGS

The invention will be described with reference to the accompanying drawings, wherein like numbers reference like elements.

FIG. 1 is a schematic cross-sectional view showing a configuration of a three-dimensional forming device according to a first embodiment.

FIG. 2 is an enlarged external view showing a head, a material ejection part, a laser irradiation part, a first lamp, and a first thermometer included in the three-dimensional forming device according to the first embodiment.

FIG. 3 is an enlarged external view showing a head, a material ejection part, a laser irradiation part, a second lamp, and a second thermometer included in the three-dimensional forming device according to the first embodiment.

FIG. 4 is an enlarged cross-sectional view schematically showing a state where a unit material is formed in a material supply region.

FIG. 5 is an enlarged cross-sectional view schematically showing a state of heating the unit material in the material supply region.

FIG. 6 is an enlarged conceptual view showing a state of a sintering material before drying.

FIG. 7 is an enlarged conceptual view showing a state of a sintering material after drying.

FIG. 8 is a flowchart showing a three-dimensional forming method according to a second embodiment.

FIG. 9 is a partial cross-sectional view showing a step in the three-dimensional forming method according to the second embodiment.

FIG. 10 is a partial cross-sectional view showing a step in the three-dimensional forming method according to the second embodiment.

FIG. 11 is a partial cross-sectional view showing a step in the three-dimensional forming method according to the second embodiment.

FIG. 12 is a partial cross-sectional view showing a state of a unit material in a heating step of the three-dimensional forming method according to the second embodiment.

FIG. 13 is a partial cross-sectional view showing a step in the three-dimensional forming method according to the second embodiment.

FIG. 14 is a partial cross-sectional view showing a state of a unit material in a drying step of the three-dimensional forming method according to the second embodiment.

FIG. 15 is a partial cross-sectional view showing a step in the three-dimensional forming method according to the second embodiment.

FIG. 16 is a partial cross-sectional view showing a step in the three-dimensional forming method according to the second embodiment.

FIG. 17 is a conceptual plan view illustrating the placement of unit materials in the three-dimensional forming method according to the second embodiment.

FIG. 18 is a cross-sectional view taken along the line A-A′ in FIG. 17.

FIG. 19 is a partial cross-sectional view showing a step in the three-dimensional forming method according to the second embodiment.

FIG. 20 is a partial cross-sectional view showing a step in the three-dimensional forming method according to the second embodiment.

FIG. 21 is a partial cross-sectional view showing a step in the three-dimensional forming method according to the second embodiment.

FIG. 22 is a partial cross-sectional view showing a step in the three-dimensional forming method according to the second embodiment.

FIG. 23 is a conceptual plan view illustrating the placement of unit materials in the three-dimensional forming method according to the second embodiment.

FIG. 24 is a partial cross-sectional view showing a step in the three-dimensional forming method according to the second embodiment.

FIG. 25 is a partial cross-sectional view showing a step in the three-dimensional forming method according to the second embodiment.

FIG. 26 is a partial cross-sectional view showing a step in the three-dimensional forming method according to the second embodiment.

FIG. 27 is a partial cross-sectional view showing a step in the three-dimensional forming method according to the second embodiment.

FIG. 28 is a schematic structural view showing a three-dimensional formed article according to a third embodiment.

FIG. 29 is a conceptual view illustrating the placement of sintered bodies which constitute a sintered single layer of the three-dimensional formed article according to the third embodiment.

FIG. 30 is a conceptual view illustrating the placement of sintered bodies which constitute a sintered single layer of the three-dimensional formed article according to the third embodiment.

FIG. 31 is a conceptual view illustrating the placement of sintered bodies which constitute a sintered single layer of the three-dimensional formed article according to the third embodiment.

FIG. 32 is a conceptual view illustrating the placement of sintered bodies which constitute a sintered single layer of the three-dimensional formed article according to the third embodiment.

FIG. 33 is a conceptual view illustrating the placement of sintered bodies which constitute a sintered single layer of the three-dimensional formed article according to the third embodiment.

FIG. 34 is a conceptual view illustrating the placement of sintered bodies which constitute a sintered single layer of the three-dimensional formed article according to the third embodiment.

FIG. 35 is a conceptual view illustrating the placement of sintered bodies which constitute a sintered single layer of the three-dimensional formed article according to the third embodiment.

FIG. 36 is a cross-sectional view taken along the line B-B′ in FIG. 31.

### DESCRIPTION OF EXEMPLARY EMBODIMENTS

Hereinafter, embodiments according to the invention will be described with reference to the accompanying drawings.

### First Embodiment

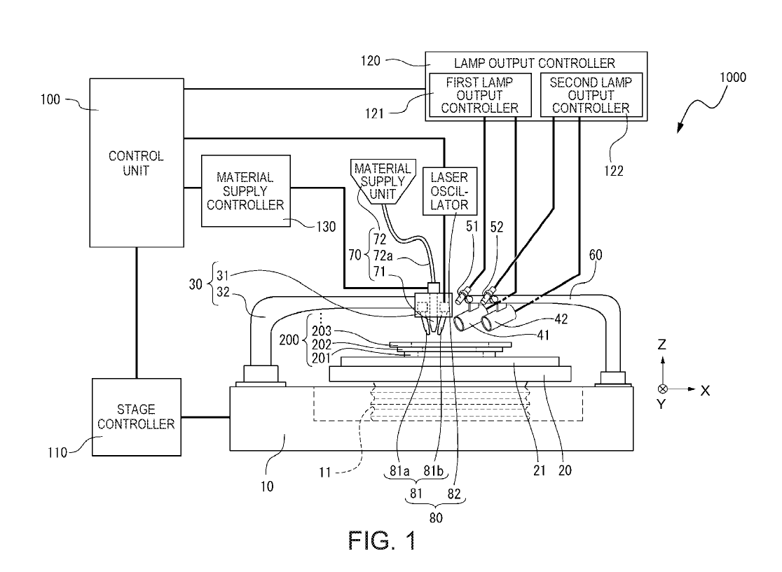

FIG. 1 is a schematic cross-sectional view showing a configuration of a three-dimensional forming device according to a first embodiment. The term “three-dimensional forming” as used herein refers to a process for forming a so-called “three-dimensional shaped article”, and also includes, for example, a process for forming a shape with a thickness even if the shape is a plate shape or a so-called two-dimensional shape.

As shown in FIG. 1, a three-dimensional forming device 1000 includes a base 10 and a stage 20 which is provided drivably in the X, Y, and Z directions shown in the drawing by a drive device 11 as a drive section provided in the base 10. Further, the three-dimensional forming device 1000 includes a head support part 30 including a head 31 as a holding section which holds a material supply section and an energy irradiation section, which will be described later, and a support arm 32, one end of which is fixed to the base 10, and to the other end of which the head 31 is held and fixed. Further, the three-dimensional forming device 1000 includes a lamp support part 60, one end of which is fixed to the base 10, and to the other end of which a first halogen lamp 41 (hereinafter referred to as “first lamp 41”) as a first heating section, a second halogen lamp 42 (hereinafter referred to as “second lamp 42”) as a second heating section, a non-contact type first thermometer 51 as a first temperature detection section which measures the temperature of a region to be heated by the first lamp 41, and a non-contact type second thermometer 52 as a second temperature detection section which measures the temperature of a region to be heated by the second lamp 42 are held and fixed. In this embodiment, a configuration in which the stage 20 is driven in the X, Y, and Z directions by the drive device 11 will be described, however, the invention is not limited thereto, and any configuration may be adopted as long as the stage 20 and the head 31 can be relatively driven in the X, Y, and Z directions.

Then, on the stage 20, partially formed articles 201, 202, and 203 are formed in layers in the process for forming a three-dimensional formed article 200. In the formation of the three-dimensional formed article 200, thermal energy is irradiated by a laser, which will be described later, and therefore, in order to protect the stage 20 from heat, a plate 21 having heat resistance is used, and the three-dimensional formed article 200 may be formed on the plate 21. As the plate 21, for example, a metal plate made of a heat-resistant metal, or a ceramic plate is preferably used. In this embodiment, a metal plate 21 having heat resistance (hereinafter referred to as “plate 21”) is shown as an example, and by using a heat-resistant metal, high heat resistance can be obtained. Further, the heat-resistant metal has low reactivity with a supply material to be sintered or fused, and thus, the deterioration of the three-dimensional formed article 200 can be prevented. Incidentally, in FIG. 1, for the sake of convenience of explanation, the three layers of the partially formed articles 201, 202, and 203 are shown as an example, however, the partially formed articles are stacked until the desired shape of the three-dimensional formed article 200 is obtained.

In the head 31, a material ejection part 71 as an ejection section included in a material supply device 70 as a material supply section, a laser irradiation part 81 as an energy irradiation part included in a laser irradiation device 80 as an energy irradiation section are held. In this embodiment, the laser irradiation part 81 includes a first laser irradiation part 81a and a second laser irradiation part 81b.

The three-dimensional forming device 1000 includes a control unit 100 as a control section which controls the stage 20, the material ejection part 71 included in the material supply device 70, the laser irradiation device 80, and the lamps and 42 based on, for example, data for forming the three-dimensional formed article 200 output from a data output device such as a personal computer (not shown). The control unit 100 includes, although not shown in the drawing, at least a drive control part for the stage 20, an operation control part for the material ejection part 71, an output control part for the lamps 41 and 42, and an operation control part for the laser irradiation device 80. Then, the control unit 100 includes a control part which drives and operates the stage 20, the material ejection part 71, the lamps 41 and 42, and the laser irradiation device 80 in corporation with one another.

The stage 20 is movably provided on the base 10, and a signal for controlling the start and stop of the movement, moving direction, moving amount, moving speed, or the like of the stage 20 is generated in a stage controller 110 based on a control signal from the control unit 100 and sent to the drive device 11 included in the base 10, and the stage 20 moves in the X, Y, or Z direction shown in the drawing.

The material ejection part 71 is fixed to the head 31, and a signal for controlling a material ejection amount from the material ejection part 71 or the like is generated in a material supply controller 130 based on a control signal from the control unit 100, and a predetermined amount of the material is ejected from the material ejection part 71 based on the generated signal.

To the material ejection part 71, a supply tube 72a as a material supply path from a material supply unit 72 included in the material supply device 70 is extended and connected. In the material supply unit 72, a sintering material containing the raw material of the three-dimensional formed article 200 to be formed by the three-dimensional forming device 1000 according to this embodiment is housed as the supply material. The sintering material as the supply material is a composition in the form of a slurry (or a paste) obtained by kneading a simple substance powder of a metal to serve as the raw material of the three-dimensional formed article 200, for example, magnesium (Mg), iron (Fe), cobalt (Co), chromium (Cr), aluminum (Al), titanium (Ti), nickel (Ni), an alloy containing at least one metal among these (for example, a maraging steel, stainless steel, a cobalt-chrome-molybdenum alloy, a titanium alloy, a nickel-based alloy, an aluminum alloy, or the like) or the like, or a mixed powder thereof, with a solvent and a binder. As the metal powder, a metal powder having an average particle diameter of 10 μm or less is preferred.

Examples of the solvent or dispersion medium include various types of water such as distilled water, pure water, and RO water, and other than these, alcohols such as methanol, ethanol, 2-propanol, 1-butanol, 2-butanol, octanol, ethylene glycol, diethylene glycol, and glycerin, ethers (cellosolves) such as ethylene glycol monomethyl ether (methyl cellosolve), ethylene glycol monoethyl ether (ethyl cellosolve), and ethylene glycol monophenyl ether (phenyl cellosolve), esters such as methyl acetate, ethyl acetate, butyl acetate, and ethyl formate, ketones such as acetone, methyl ethyl ketone, diethyl ketone, methyl isobutyl ketone, methyl isopropyl ketone, and cyclohexanone, aliphatic hydrocarbons such as pentane, hexane, and octane, cyclic hydrocarbons such as cyclohexane and methylcyclohexane, aromatic hydrocarbons having a long-chain alkyl group and a benzene ring such as benzene, toluene, xylene, hexylbenzene, heptylbenzene, octylbenzene, nonylbenzene, decylbenzene, undecylbenzene, dodecylbenzene, tridecylbenzene, and tetradecylbenzene, halogenated hydrocarbons such as methylene chloride, chloroform, carbon tetrachloride, and 1,2-dichloroethane, aromatic heterocycles such as pyridine, pyrazine, furan, pyrrole, thiophene, and methylpyrrolidone, nitriles such as acetonitrile, propionitrile, and acrylonitrile, amides such as N,N-dimethylformamide and N,N-dimethylacetamide, carboxylates, and other various types of oils. Further, by using a silicone oil or the like as a heat-resistant solvent, the fluidity can be improved.

The binder is not limited as long as it is soluble in the above-mentioned solvent or dispersion medium. For example, an acrylic resin, an epoxy resin, a silicone resin, a cellulosic resin, a synthetic resin, or the like can be used. Further, for example, a thermoplastic resin such as polylactic acid (PLA), polyamide (PA), or polyphenylene sulfide (PPS) can also be used. In addition, the above-mentioned resin such as an acrylic resin may be dispersed in the above-mentioned solvent or dispersion medium not in a soluble state but in a fine particle state. In the case of using a thermoplastic resin, the flexibility of the thermoplastic resin is maintained by heating the material ejection part 71 and the material supply unit 72.

The lamps 41 and 42 fixed to the lamp support part 60 have heat radiation regions, respectively, which are different from each other. The heat radiated from the first lamp 41 heats the material supply region in which the material ejected from the material ejection part 71 on the plate 21 or on the uppermost layer of the partially formed article 201, 202, or 203, in this example, on the partially formed article 203 to a predetermined temperature. Although a detailed description will be given later, part of the material landed on the plate 21 or the partially formed article 203 as the uppermost layer heated by the first lamp 41 is dried.

Further, the heat radiated from the second lamp 42 further dries the material ejected from the material ejection part 71 and landed on the plate 21 or on the uppermost layer of the partially formed article 201, 202, or 203, in this example, on the partially formed article 203 in addition to the partial drying by the heat of the material supply region heated by the first lamp 41. That is, by the heat radiated from the lamps 41 and 42, the liquid component is evaporated from the material containing the metal powder, the solvent or dispersion medium, and further the binder. Incidentally, the lamps 41 and 42 as the heating sections are not limited to halogen lamps. For example, heating drying by irradiation with an infrared lamp or a high frequency wave, hot air blowing, or the like may be employed.

The laser irradiation part 81 is included in the laser irradiation device 80 fixed to the head 31, and based on a control signal from the control unit 100, a laser is oscillated at a predetermined output by a laser oscillator 82, and a laser is irradiated by the laser irradiation part 81. The laser is irradiated to the supply material ejected from the material ejection part 71, and the metal powder contained in the supply material is sintered or fused and solidified. The laser to be used in the three-dimensional forming device 1000 according to this embodiment is not particularly limited, however, a fiber laser which has higher metal absorption efficiency than a carbon dioxide laser is preferred.

By the heat radiated from the lamps 41 and 42, the liquid component is evaporated from the material containing the metal powder, the solvent or dispersion medium, and further the binder, however, when the temperature exceeds the boiling point of the liquid component by excessive heating, there is a fear that the landed material may be scattered due to so-called flash boiling. Therefore, in order to avoid flash boiling, in the lamp support part 60, the thermometers 51 and 52 are provided. The thermometers 51 and 52 can measure the temperature of a measurement target in a non-contact manner, and the temperatures of the heating regions of the lamps 41 and 42 are measured, and the data of the measured temperatures are transmitted to a first lamp output controller 121 and a second lamp output controller 122 included in a lamp output controller 120. Then, the lamp output controller 120 performs control such that when the measured temperatures are higher than the predetermined temperatures in the heating regions of the lamps 41 and 42, the supply power to the lamps 41 and 42 is reduced, and when the measured temperatures are lower than the predetermined temperatures, the supply power is increased.

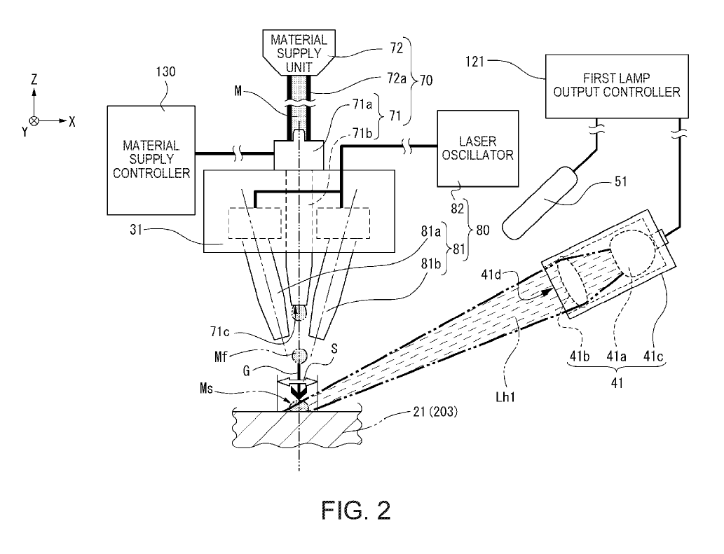

FIG. 2 is an enlarged external view showing the head 31, the material ejection part 71 and the laser irradiation part 81 held by the head 31, the first lamp 41, and the first thermometer 51 shown in FIG. 1, and is an external view seen from the Y direction shown in FIG. 1. As shown in FIG. 2, the material ejection part 71 held by the head 31 includes an ejection nozzle 71b and an ejection drive part 71a which causes the ejection nozzle 71b to eject a predetermined amount of the material. To the ejection drive part 71a, the supply tube 72a connected to the material supply unit 72 is connected, and a sintering material M is supplied through the supply tube 72a. The ejection drive part 71a is provided with an ejection drive device (not shown), and the sintering material M is sent to the ejection nozzle 71b based on a control signal from the material supply controller 130. Then, the material is prepared to be made to fly to a substantially gravity direction G toward the plate 21 or the partially formed article 203 as the uppermost layer shown in FIG. 1 from an ejection port 71c of the ejection nozzle 71b as a material flying body Mf in the form of a droplet to become a substantially spherical shape.

Here, a heat beam Lh1 is irradiated from the first lamp 41 as the heating section to a material supply region S on the upper surface of the plate 21 or the partially formed article 203 as the uppermost layer shown in FIG. 1 on which the material flying body Mf is landed, and the material supply region S of the plate 21 or the partially formed article 203 as the uppermost layer shown in FIG. 1 is heated to a predetermined temperature.

The predetermined temperature is preferably a temperature capable of evaporating the liquid component containing the solvent or dispersion medium, or the binder or the like contained in the material flying body Mf to be landed on the material supply region S, that is, in the sintering material M, and also not exceeding the boiling point of the liquid component. That is, the predetermined temperature is a temperature at which when the material flying body Mf is landed and formed on the material supply region S as a unit droplet material Ms (hereinafter referred to as “unit material Ms”), the liquid component containing the solvent or dispersion medium, or the binder or the like contained in the unit material Ms is evaporated and fixed on the material supply region S.

As shown in FIG. 2, the first lamp 41 houses a light source 41a to serve as a heat source, a condenser lens 41b which converges the heat beam Lh1 emitted from the light source 41a on an irradiation target, and a lens housing part 41c which houses the light source 41a and the condenser lens 41b, and includes an opening 41d for emitting the heat beam Lh1 converged from the condenser lens 41b. Incidentally, the first lamp 41 is not limited to the configuration shown in FIG. 2, and may be a light source (lamp) including a condensing reflection part (reflector).

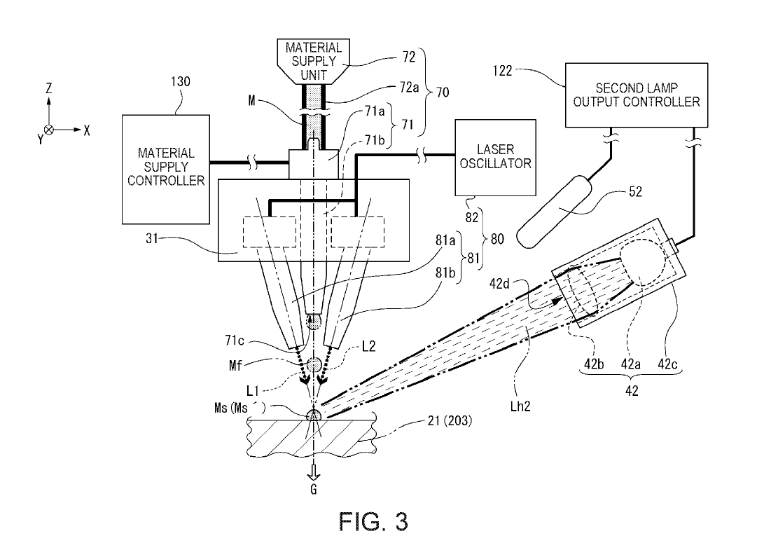

After heating the material supply region S shown in FIG. 2 by the first lamp 41 described above, as shown in FIG. 3, the heating of the unit material Ms landed on the material supply region S is performed by the second lamp 42. FIG. 3 is an enlarged external view showing the head 31, the material ejection part 71 and the laser irradiation part 81 held by the head 31, the second lamp 42, and the second thermometer 52 shown in FIG. 1, and is an external view seen from the Y direction shown in FIG. 1.

As shown in FIG. 3, the sintering material M ejected from the ejection port 71c of the ejection nozzle 71b becomes the material flying body Mf in the form of a droplet, that is, to become a substantially spherical shape, and flies toward the plate 21 or the partially formed article 203 as the uppermost layer shown in FIG. 1, and lands on the plate 21 or the partially formed article 203 and formed on the plate 21 or the partially formed article 203 as the unit material Ms. Then, by the heat of the material supply region S heated as shown in FIG. 2, at least part of the liquid component such as the solvent or dispersion medium contained in the unit material Ms is evaporated.

Then, a unit material Ms′ which is formed on the plate 21 or the partially formed article 203 and in which part of the liquid component such as the solvent or dispersion medium is evaporated is irradiated with a heat beam Lh2 to be emitted from the second lamp 42 as the heating section, and the remaining liquid component such as the solvent or dispersion medium, and further the binder or the like contained in the unit material Ms′ is removed, and therefore, the unit material Ms′ is converted into a dried dry unit material Ms″. Incidentally, the heat beam Lh2 preferably heats the unit material Ms′ to a temperature not exceeding the boiling point of the liquid component containing the solvent or dispersion medium, and the like contained in the unit material Ms′. That is, there is a fear that by heating the unit material Ms′ to a temperature exceeding the boiling point of the liquid component containing the solvent or dispersion medium, and the like contained in the unit material Ms′, flash boiling of the liquid component may occur to scatter the metal powder in the unit material Ms′. In order to avoid this, it is preferred to perform drying at a temperature not exceeding the boiling point of the liquid component.

Then, on the dry unit material Ms”, a laser L1 is irradiated from the first laser irradiation part 81a and a laser L2 is irradiated from the second laser irradiation part 81b, and the dry unit material Ms” is heated and sintered.

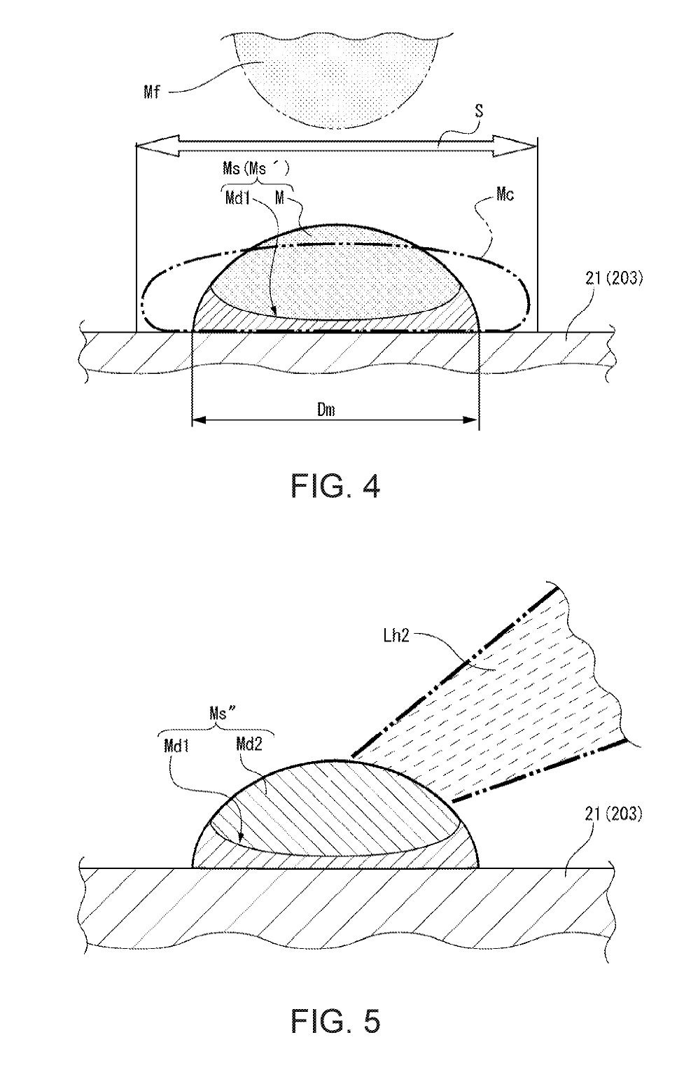

FIG. 4 is an enlarged cross-sectional view schematically showing a state where the unit material Ms is formed in the material supply region S heated by the first lamp 41 shown in FIG. 2. As shown in FIG. 4, the material flying body Mf flies toward the material supply region S of the plate 21 or the partially formed article 203 as the uppermost layer shown in FIG. 1 and lands on the plate 21 or the partially formed article 203 and is formed as the unit material Ms. At this time, as shown in FIG. 2, the material supply region S has been heated by the first lamp 41, and therefore, the evaporation of the liquid component such as the solvent or dispersion medium contained in the material flying body Mf is started simultaneously with the landing of the material flying body Mf on the material supply region S, and in a state of the unit material Ms after landing, a portion of the unit material Ms in proximity to the material supply region S is converted into a dry part Md1, and in the other portion, the unit material Ms′ in a state of the composition of the sintering material M containing the liquid component containing the solvent or dispersion medium and the binder or the like is constituted.

Then, as shown in FIG. 5, the unit material Ms′ shown in FIG. 4 is irradiated with the heat beam Lh2 from the second lamp 42, and the liquid component in the undried portion in the unit material Ms′ , that is, in the portion of the sintering material M containing the liquid component containing the solvent or dispersion medium and the binder or the like is evaporated, whereby a dry part Md2 is formed. Then, the dry unit material Ms” constituted by the dry parts Md1 and Md2 both obtained by drying by evaporation or thermal decomposition of the solvent or dispersion medium, or the binder or the like is formed.

As shown in FIG. 4, in a state of the unit material Ms′ in which the dry part Md1 and the sintering material M are mixed, a low viscosity for obtaining given fluidity is imparted to the sintering material M in order to eject the material in the form of a droplet. If the material flying body Mf is landed on the material supply region S in an unheated state, the unit material Ms is likely to flow along the surface of the material supply region S. Therefore, as shown in FIG. 4, a unit material Mc in a largely spread state with respect to the landing diameter Dm of the given unit material Ms is formed.

Therefore, by heating the material supply region S by the first lamp 41, the liquid component containing the solvent or dispersion medium and the binder or the like is evaporated immediately after landing the material flying body Mf on the material supply region S, and the dry part Md1 in which the viscosity of the sintering material M is increased is formed, whereby the unit material Ms′ can be obtained while maintaining the landing diameter Dm. According to this, in the three-dimensional forming method, which will be described later, the unit material Ms′ (or Ms“) can be accurately placed on the plate 21 or the partially formed article 203 as the uppermost layer shown in FIG. 1.

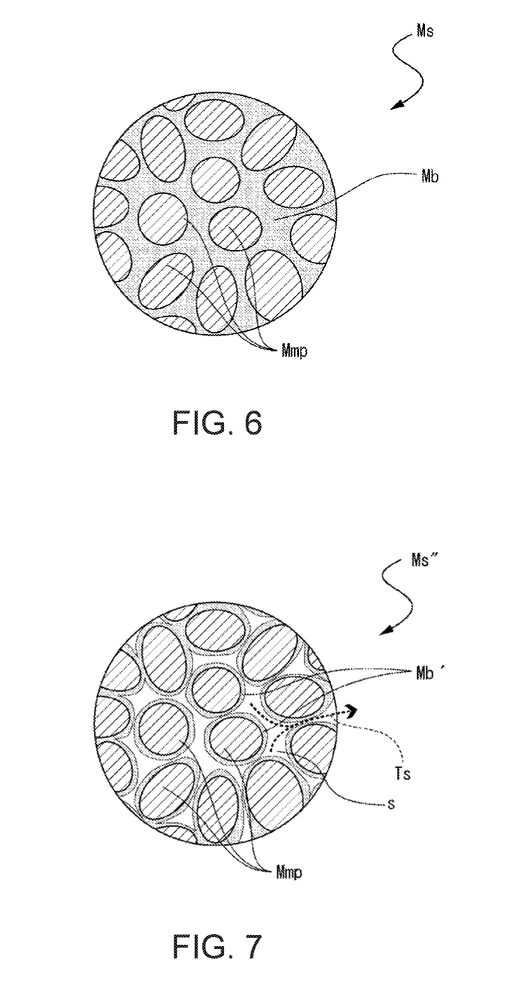

A change in a state of drying by evaporating the liquid component containing the solvent or dispersion medium and the binder or the like contained in the unit material Ms by the lamps 41 and 42 in the three-dimensional forming device 1000 according to this embodiment will be described with reference to FIGS. 6 and 7. FIG. 6 is an enlarged view showing a state before drying and FIG. 7 is an enlarged view showing a state after drying.

As shown in FIG. 6, the unit material Ms lands on the plate 21 or the partially formed article 203 in a state where the metal powder Mmp of the material which constitutes the three-dimensional formed article 200 is dispersed substantially uniformly in a composition Mb containing the solvent or dispersion medium and the binder. When the unit material is irradiated with a heat beam Lh emitted from the lamp 40, as shown in FIG. 7, the solvent or dispersion medium contained in the composition Mb containing the solvent or dispersion medium and the binder is evaporated by the heat of the heat beam Lh, and the solid component other than the liquid component contained in the composition Mb, for example, a binder Mb′ after drying containing a resin component remains around the metal powder Mmb, and the unit material Ms′ is formed as the dry sintering material after drying in which spaces s corresponding to the volume of the liquid component are formed. Some spaces s form a communication path Ts communicating with each other, and the communication path Ts communicates with the outside of the unit material Ms” after drying.

Then, as shown in FIG. 3, to the dry unit material Ms” after drying, the laser L1 is emitted from the first laser irradiation part 81a and the laser L2 is emitted from the second laser irradiation part 81b. By the laser L1 and the laser L2, the dry unit material Ms” is heated and sintered.

At this time, the lasers L1 and L2 apply large thermal energy to the unit material Ms” after drying in a short time. If the thermal energy of the lasers L1 and L2 is irradiated to the unit material Ms before drying shown in FIG. 6, there is a fear that the liquid component such as the solvent or dispersion medium contained in the unit material Ms may be explosively evaporated to scatter the metal powder Mmp. However, by drying the unit material Ms and irradiating the lasers L1 and L2 to the material in a state of the dry unit material Ms” after drying shown in FIG. 7, the explosive evaporation of the liquid component can be avoided, and thus, the scattering of the metal powder Mmp can be prevented. Further, when the binder Mb′ after drying shown in FIG. 7 is gasified and evaporated by the thermal energy of the lasers L1 and L2, the binder is released in the space s or to the outside of the dry unit material Ms” through the communication path Is of the space s, and thus, the metal powder Mmp can be sintered without scattering.

The material flying body Mf to be ejected from the ejection port 71c is preferably ejected from the ejection port 71c toward the gravity direction G indicated by the arrow in the drawing. That is, it becomes possible to eject the material flying body Mf in the gravity direction G by allowing the material flying body Mf to reliably fly toward the landing position so that the unit material Ms is placed at a desired position. Then, the lasers L1 and L2 to be irradiated to the dry unit material Ms” ejected and landed toward the gravity direction G, and then dried are irradiated in the direction crossing the gravity direction G.

As described above, there is a fear that the temperature of the unit material Ms to be ejected subsequently may exceed a predetermined drying temperature due to the concentration of the thermal energy of the material supply region S heated by the first lamp 41, the thermal energy of the heat beam Lh from the second lamp 42, and the thermal energy of the lasers L1 and L2 in the vicinity of the dry unit material Ms” after sintering subjected to irradiation with the lasers L1 and L2 by the irradiation with the lasers L1 and L2 of the dry unit material Ms” obtained by heating and drying by the second lamp 42 of the unit material Ms′ after drying obtained by heating and drying by being landed on the material supply region S heated by the first lamp 41, and then heating and drying by the second lamp 42. Therefore, by the first thermometer 51, the temperature of the material supply region S for the unit material Ms to be ejected subsequently is measured. Then, the output power to the light source 41a included in the first lamp 41 is controlled by the first lamp output controller 121 of the lamp output controller 120 based on the data of the measured temperature, whereby the temperature of the material supply region S for the unit material Ms to be ejected subsequently can be made to fall within a predetermined temperature range. Further, the temperature of the unit material Ms′ after landing is measured by the second thermometer 52, and the output power to a light source 42a included in the second lamp 42 is controlled by the second lamp output controller 122 of the lamp output controller 120 based on the data of the measured temperature, whereby the drying temperature of the unit material Ms′ can be made to fall within a predetermined temperature range.

As described above, the material supply device 70 included in the three-dimensional forming device 1000 according to this embodiment ejects the material flying body Mf in the form of a droplet from the material ejection part 71. In a configuration in which a metal fine powder is ejected from a material supply port and sintered by an energy beam such as a laser in the related art, an adhesive force between particles is increased, and the powder becomes a so-called highly adhesive powder, and therefore, for example, when the powder is conveyed and ejected by compressed air or the like, the powder is easily adhered to a flow path, and thus, the fluidity is significantly deteriorated. However, in this embodiment, excellent fluidity can be imparted using the composition containing the metal fine powder having an average particle diameter of 10 μm or less and the solvent and the binder as the sintering material M.

Moreover, by imparting high fluidity, a very small amount of the sintering material M can be ejected in the form of a droplet from the ejection port 71c of the material ejection part 71, and the unit material Ms can be placed on the plate 21 or the partially formed article 203. Further, the material supply region S is heated by the first lamp 41, and the unit material Ms is dried immediately after the unit material Ms is landed on the plate 21 or the partially formed article 203 and is converted into the unit material Ms′ in which the dry part Md1 is formed, whereby the deformation of the unit material Ms′ after landing, for example, the flowing or the like of the material along the upper surface of the plate 21 or the partially formed article 203 can be suppressed. That is, a minute three-dimensional formed article as a continuous body of the formation of a very small amount.

Incidentally, the three-dimensional forming device 1000 according to the first embodiment described above is configured to include two laser irradiation parts 81a and 81b, however, the invention is not limited thereto. For example, the three-dimensional forming device 1000 may include one laser irradiation part or three or more laser irradiation parts. Further, the laser irradiation parts 81a and 81b are attached to the head 31 such that the lasers L1 and L2 are irradiated in the direction crossing the gravity direction G, however, the invention is not limited thereto. Further, the configuration in which in the three-dimensional forming device 1000 according to this embodiment, the lasers L1 and L2 are used as energy for irradiation has been described, however, the invention is not limited thereto. The laser irradiation part may be any as long as it is a part which supplies a heat amount capable of sintering the sintering material M, and, for example, a high-frequency wave, a halogen lamp, or the like may be used.

### Second Embodiment

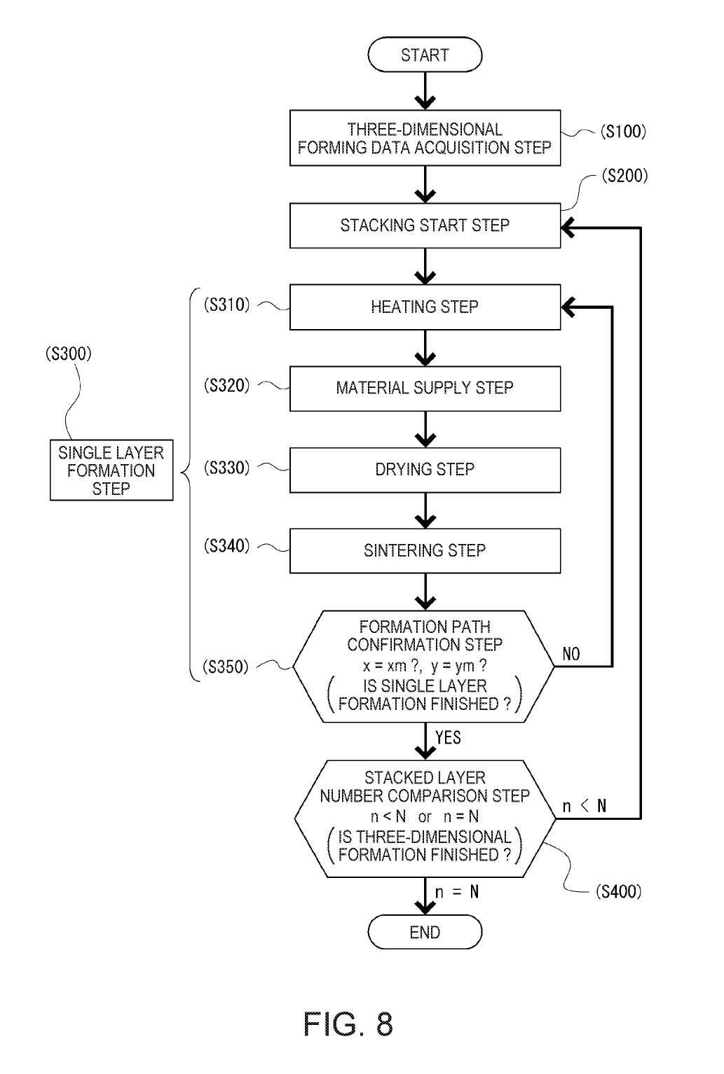

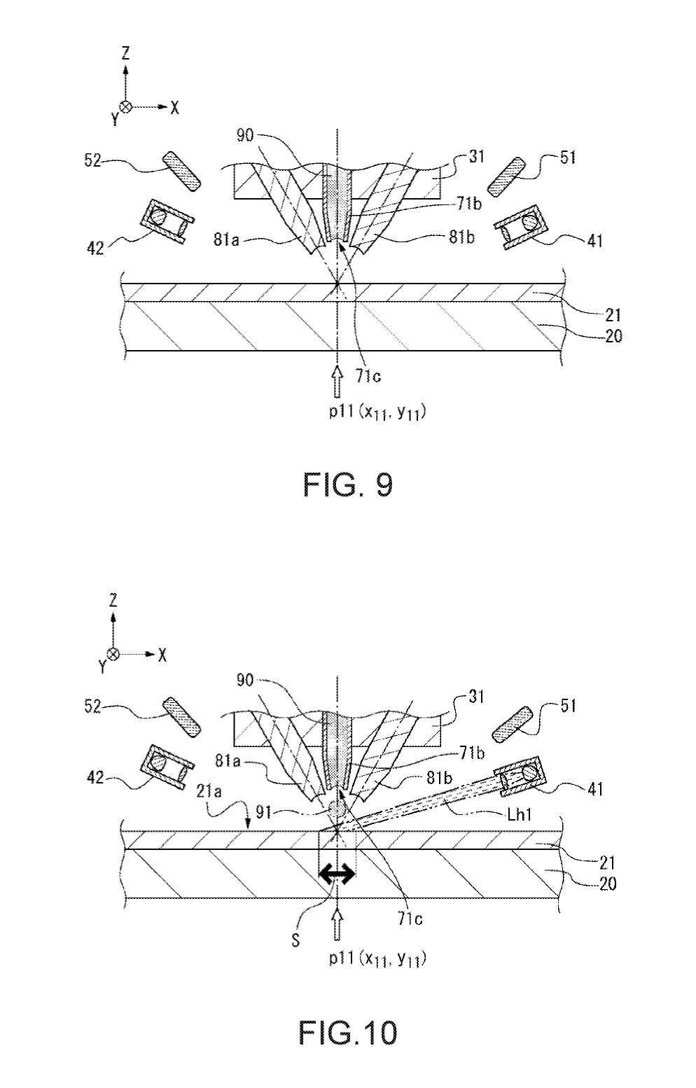

A three-dimensional forming method according to a second embodiment is a method for forming the three-dimensional formed article 200 by the three-dimensional forming device 1000 according to the first embodiment described above. A flowchart showing the method for forming the three-dimensional formed article 200 according to the second embodiment is shown in FIG. 8, and the formation methods in the respective steps in the flowchart shown in FIG. 8 are shown in FIGS. 9 to 27.

### Three-Dimensional Forming Data Acquisition Step

As shown in FIG. 8, in the three-dimensional forming method according to this embodiment, a three-dimensional forming data acquisition step (S100) in which the three-dimensional forming data of the three-dimensional formed article 200 is acquired in the control unit 100 (see FIG. 1) from, for example, a personal computer (not shown) or the like is performed. The three-dimensional forming data acquired in the three-dimensional forming data acquisition step (S100) is sent to the stage controller 110, the material supply controller 130, the laser oscillator 82, and the lamp output controller 120 as the control data from the control unit 100, and then, the step is shifted to a stacking start step.

### Stacking Start Step

In the stacking start step (S200), as shown in FIG. 9 which shows the three-dimensional forming method, the head 31 is placed at a predetermined relative position with respect to the plate 21 placed on the stage 20. At this time, in the XY plane (see FIG. 1), the stage 20 provided with the plate 21 is moved so that the material flying body Mf (see FIG. 3) which is the sintering material in the form of a droplet ejected from the ejection port 71c of the ejection nozzle 71b of the material ejection part 71 lands at a coordinate position p11 (x11, y11) of the stage 20, which is the starting point of formation based on the above-mentioned three-dimensional forming data, and the formation of a three-dimensional formed article is started, and then, the step is shifted to a single layer formation step. Incidentally, for the sake of convenience of explanation, a description will be given with respect to a case where the first lamp 41 and the first thermometer 51, and the second lamp 42 and the second thermometer 52 are placed on the right and left sides with the head 31 interposed therebetween in the drawing.

### Single Layer Formation Step

As shown in FIG. 8, the single layer formation step (S300) includes a heating step (S310), a material supply step (S320), a drying step (S330), and a sintering step (S340). Hereinafter, the respective steps included in the single layer formation step will be described.

### Heating Step

The single layer formation step (S300) starts with the heating step (S310). In the heating step (S310), as shown in FIG. 10, a supply material 90 introduced into the ejection nozzle 71b is ejected from the ejection port 71c and flies toward the upper surface 21a of the plate 21 as a material flying body 91, and the material supply region S in which the material lands on the upper surface 21a is heated by the heat beam Lh1 radiated from the first lamp 41. The heating temperature of the material supply region S by the heat beam Lh1 is set to a temperature which is lower than the boiling point of the solvent or dispersion medium contained in the supply material 90 and enables the evaporation of the solvent or dispersion medium. The predetermined temperature to be set is appropriately measured by the first thermometer 51, and sent to the first lamp output controller 121 shown in FIG. 1, and the input power of the first lamp 41 is controlled so that the material supply region S can be maintained at the appropriate temperature.

### Material Supply Step

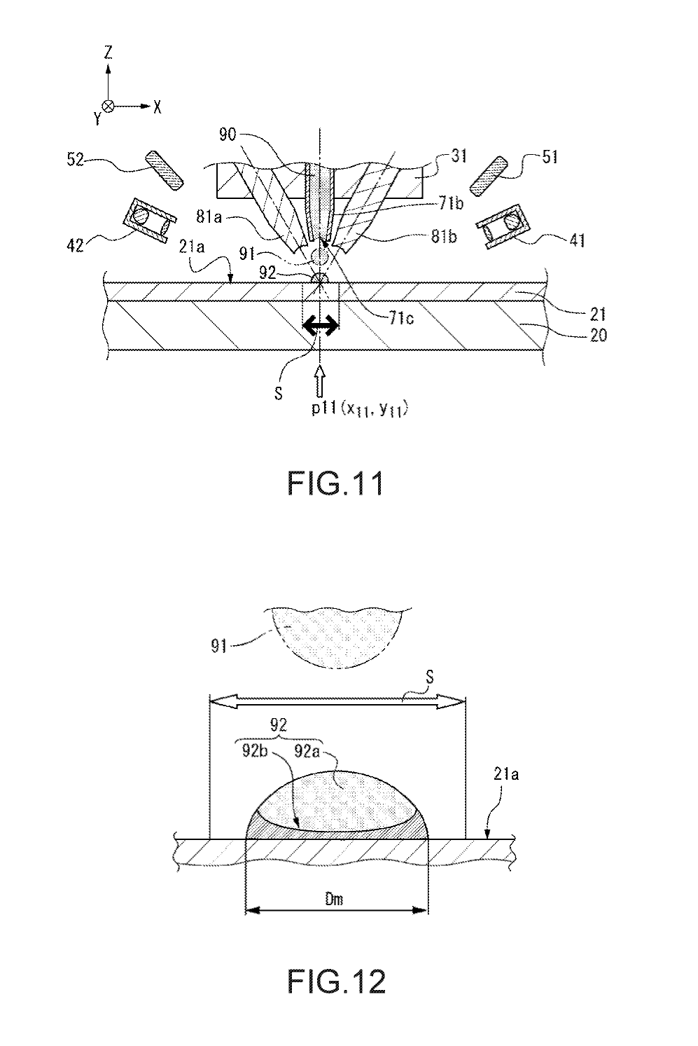

After the material supply region S on the upper surface 21a of the plate 21 on which the material flying body 91 is landed is heated to the predetermined temperature in the heating step (S310), the step is shifted to the material supply step (S320). In the material supply step (S320), as shown in FIG. 11, the plate 21 is moved so that the ejection nozzle 71b held by the head 31 faces the plate 21 at the position p11 (x11, y11) as the predetermined position in the stacking start step (S200), and the supply material 90 as the sintering material is ejected in the gravity direction from the ejection nozzle 71b through the ejection port 71c as the material flying body 91 in the form of a droplet toward the plate 21. As the supply material 90, a material prepared in the form of a slurry (or a paste) by kneading a metal to serve as the raw material of the three-dimensional formed article 200, for example, a simple substance powder of stainless steel or a titanium alloy, or a mixed powder of stainless steel and copper (Cu), which are difficult to alloy, or stainless steel and a titanium alloy, or a titanium alloy and cobalt (Co) or chromium (Cr) with a solvent and a binder.

The material flying body 91 lands on the upper surface 21a of the plate 21 and is formed at the position p11 (x11, y11) on the upper surface 21a as a unit droplet material 92 (hereinafter referred to as “unit material 92”). The unit material 92 formed on the upper surface 21a is constituted by an undried part 92a which is not dried and a dry part 92b which is formed by evaporating the liquid component such as the solvent or dispersion medium contained in the supply material 90 in the vicinity of the upper surface 21a by the heat of the material supply region S of the plate 21 heated as shown in FIG. 12 which shows an enlarged cross-sectional view of a portion of the unit material 92. Here, the undried part 92a has the same composition as that of the supply material 90 and is a material containing the liquid component such as the solvent or dispersion medium.

To the supply material 90, high fluidity is imparted so that the supply material 90 can be ejected from the ejection port 71c. Due to this, there is a fear that the material flying body 91 may flow and diffuse along the plane of the upper surface 21a when landing on the upper surface 21a of the plate 21. However, the dry part 92b which loses fluidity due to the heat of the heated material supply region S is formed simultaneously with the landing of the material flying body 91 on the heated material supply region S, and the predetermined landing diameter Dm of the unit material 92 can be obtained. Then, after the unit material 92 having the dry part 92b partially is supplied to the upper surface 21a of the plate 21, the step is shifted to the drying step.

### Drying Step

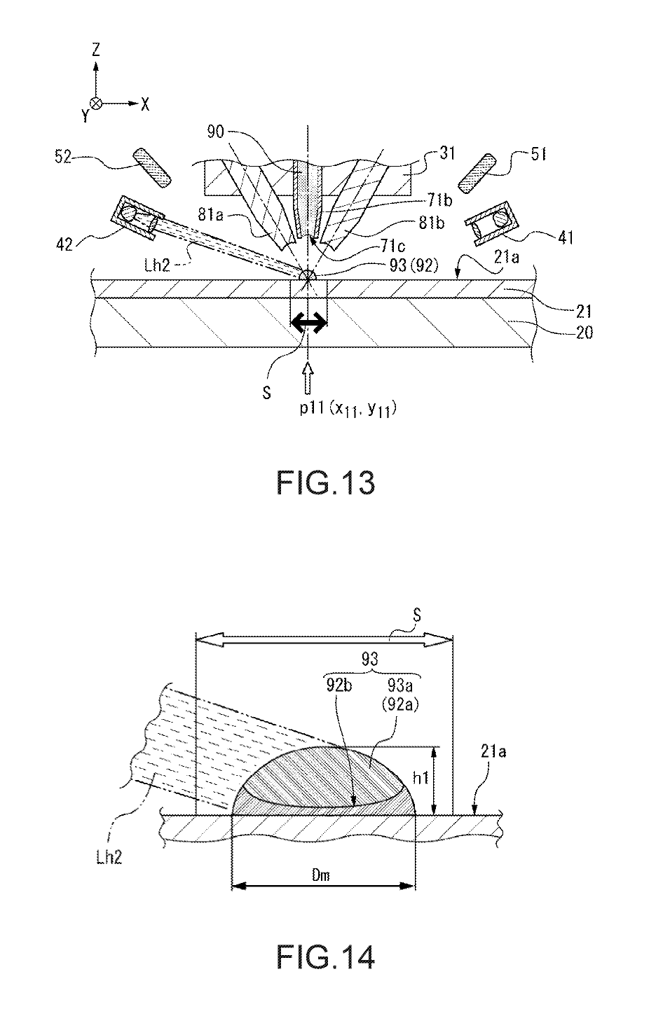

In the drying step (S330), as shown in FIG. 13, the heat beam. Lh2 is irradiated from the second lamp 42 to the unit material 92 landing on the upper surface 21a of the plate 21 in the material supply step (S320). At this time, the temperature of the unit material 92 on the plate 21 is measured by the second thermometer 52, and an electric power to be input to the second lamp 42 is controlled, and the energy of the heat beam Lh2 to provide a predetermined drying temperature is irradiated to the unit material 92. Then, as shown in FIG. 14 which is an enlarged view of the unit material 92, the liquid component such as the solvent or dispersion medium contained in the undried part 92a included in the unit material 92 is evaporated to form a dry part 93a which is dried, whereby a unit material 93 as the dry sintering material after drying is formed. According to this, in addition to the dry part 92b whose fluidity is partially decreased, also the undried part 92a is converted into the unit material 93 which is dried, and thus, the wet spread of the material along the upper surface 21a can be suppressed, and the unit material 93 can ensure the height h1 (so-called “overlay amount”) from the upper surface 21a of the plate 21.

Incidentally, the heat beam Lh2 preferably heats the unit material 92 to a temperature which does not exceed the boiling point of the liquid component such as the solvent or dispersion medium contained in the undried part 92a of the unit material 92. That is, there is a fear that by heating the unit material 92 to a temperature exceeding the boiling point of the liquid component containing the solvent or dispersion medium or the like contained in the undried part 92a of the unit material 92, flash boiling of the liquid component may occur to scatter the metal powder in the unit material 92. In order to prevent this, it is preferred to perform drying at a temperature which does not exceed the boiling point of the liquid component. Further, it is more preferred that the heat beam Lh2 allows the thermal decomposition of the binder to proceed at the same temperature as the temperature used for the evaporation of the solvent or dispersion medium.

### Sintering Step

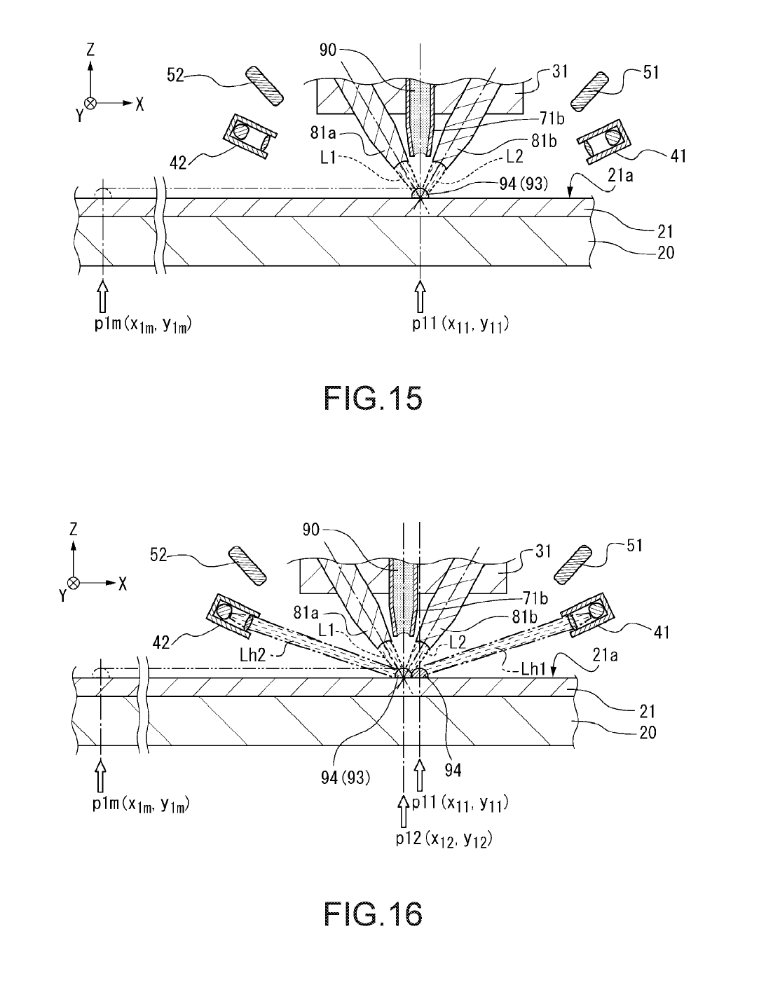

After the unit material 93 is disposed on the upper surface 21a through the drying step (S330), the sintering step (S340) is started. In the sintering step (S340), as shown in FIG. 15, the lasers L1 and L2 are irradiated in the direction crossing the gravity direction to the unit material 93 from the laser irradiation parts 81a and 81b (see FIG. 2). By the energy (heat) of the lasers L1 and L2, the binder Mb′ (see FIG. 7) after drying contained in the unit material 93 is thermally decomposed, and the metal powder particles are bound to one another, so-called sintered, or fusion-bonded to one another, whereby a sintered body 94 in the form of a metal ingot is formed at the position p11 (x11, y11). The irradiation with the lasers L1 and L2 is performed by setting the irradiation conditions according to the conditions such as the material composition, volume, or the like of the unit material 93 after drying, and after the unit material 93 is irradiated with the lasers L1 and L2 at a preset irradiation dose, the irradiation is stopped.

Then, as will be described later, the heating step (S310), the material supply step (S320), the drying step (S330), and the sintering step (S340) are repeated, and in this example, a partially formed article 201 of the first layer as the first single layer is formed. The partially formed article 201 is formed by repeating the heating step (S310), the material supply step (S320), the drying step (S330), and the sintering step (S340) m times along with the movement of the stage 20, and the m-th unit sintered body 94 is formed at a coordinate position pEND=p1m (x1m, y1m) of the stage 20, which becomes an edge portion of the partially formed article 201.

After the sintered body 94 is formed at the position p11 (x11, y11), a formation path confirmation step (S350) in which it is determined whether or not the number of repetitions of the heating step (S310), the material supply step (S320), the drying step (S330), and the sintering step (S340) has reached m times until the partially formed article 201 is formed, that is, whether or not the ejection nozzle 71b has reached the coordinate position pEND=plm (xlm, ylm) of the stage 20 is performed. In the formation path confirmation step (S350), in the case where it is determined that the number of repetitions has not reached m times, that is, the ejection nozzle 71b has not reached the coordinate position pEND=plm (x1m, y1m) of the stage 20 so that it is determined as “NO”, as shown in FIG. 8, the step is shifted to the heating step (S310) again, and as shown in FIG. 16, the stage 20 is driven so that the ejection nozzle 71b faces the stage 20 at a position p12 (x12, y12) which is the forming position of the subsequent unit material 93. Then, after the ejection nozzle 71b faces the stage 20 at the position p12 (x12, y12), the heating step (S310), the material supply step (S320), the drying step (S330), and the sintering step (S340) are performed, and thus, the sintered body 94 is formed at the position p12 (x12, y12).

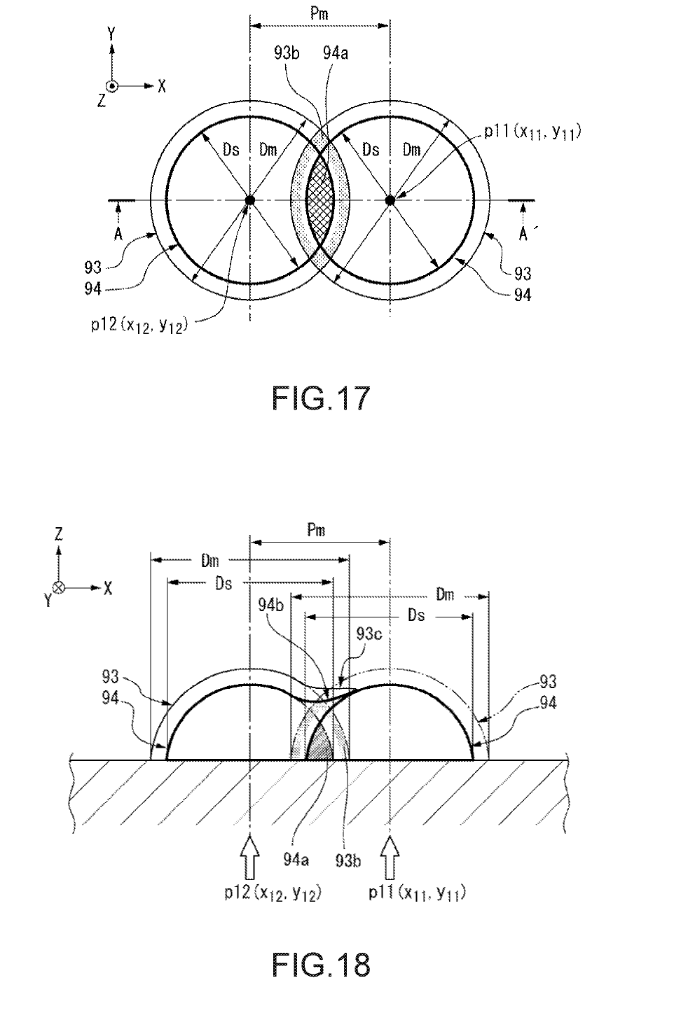

In the repeated formation of the sintered body 94, the unit materials 93 are placed and formed as shown in FIG. 17. FIGS. 17 and 18 are views for conceptually explaining the configuration of the placement and formation by illustrating the unit material 93 landed at p12 (x12, y12) which is the landing position of the adjacent unit material 93 with the position p11 (x11, y11) as the starting point where the unit material 93 shown in FIG. 16 should be landed, and FIG. 17 is a conceptual plan view seen from the head 31 side to the plate 21 in FIG. 16, and FIG. 18 is a conceptual cross-sectional view taken along the line A-A′ in FIG. 17.

As shown in FIG. 17, the unit material 93 having a diameter Dm is formed at the landing position, that is, the forming position p11 (x11, y11) of the sintered body 94, and the sintered body 94 is formed by irradiation with the lasers L1 and L2. By sintering the unit material 93 by irradiation with the lasers L1 and L2, the binder contained in the unit material 93 is removed, and therefore, the unit material 93 is shrunk, and the sintered body 94 having a sintered body diameter Ds which is smaller than the diameter Dm of the unit material 93 (hereinafter referred to as “unit material diameter Dm”) is formed.

Then, the unit material 93 is placed and formed at the forming position p12 (x12, y12) which is adjacent to and spaced apart at a distance of Pm from the sintered body 94 formed at the forming position p11 (x11, y11). Hereinafter, the distance of Pm is referred to as “ejection dot pitch Pm”. The ejection dot pitch Pm1 is set such that an overlapped ejection part 93b is formed so that a region in which the unit material 93 is not placed is not generated between the sintered body 94 formed at the forming position p11 (x11, y11) and the unit material 93 ejected and placed at the forming position p12 (x12, y12). That is, it is preferred that the unit material 93 is placed such that the ejection dot pitch Pm with respect to the unit material diameter Dm satisfies the following condition:

Pm<Dm (1).

When the unit material 93 is placed at intervals of the ejection dot pitch Pm in this manner, as shown in FIG. 18, the material in an amount corresponding to the overlapped ejection part 93b of the unit material 93 ejected at the forming position p12 (x12, y12) forms a ride-on part 93c which rides on the sintered body 94 formed at the forming position p11 (x11, y11). Then, by the sintering, the sintered body 94 formed at the forming position p12 (x12, y12) forms a ride-on part 94b and forms a sintered layer integrated with the sintered body 94 formed at the forming position p11 (x11, y11). Therefore, in order not to generate an unformed part of the sintered body 94, it is more preferred to satisfy the following condition:

Pm<(Dm+Ds)/2 (2).

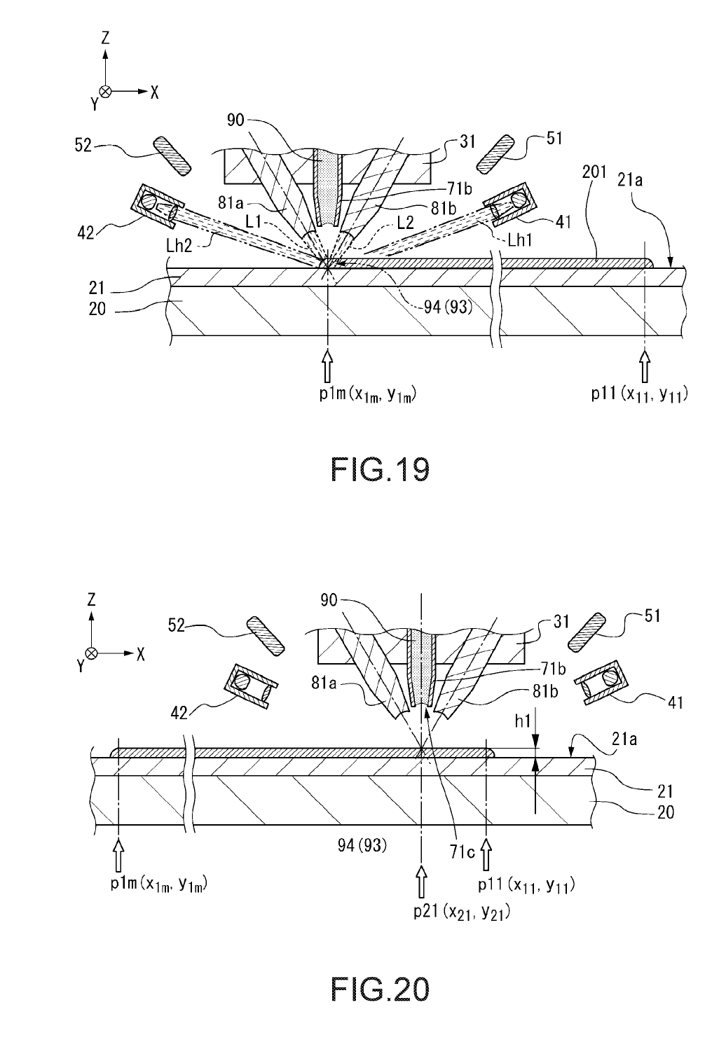

Then, as shown in FIG. 19, by repeating the heating step (S310), the material supply step (S320), the drying step (S330), and the sintering step (S340) m times while satisfying the formula (1) or the formula (2), the partially formed article 201 is formed. Then, when it is confirmed whether or not the coordinate position of the stage 20 that the ejection nozzle 71b faces at the m-th repetition is located at the coordinate position pEND=p1m (x1m, y1m) and it is determined as “YES”, the single layer formation step (S300) is finished.

### Stacked Layer Number Comparison Step

After the partially formed article 201 of the first layer as the first single layer is formed in the single layer formation step (S300), the step is shifted to a stacked layer number comparison step (S400) in which comparison with the forming data obtained in the three-dimensional forming data acquisition step (S100) is performed. In the stacked layer number comparison step (S400), the stacked layer number N of partially formed articles which constitute the three-dimensional formed article 200 and the stacked layer number n of partially formed articles stacked until the single layer formation step (S300) immediately before the stacked layer number comparison step (S400) are compared.

In the stacked layer number comparison step (S400), in the case where it is determined as n=N, it is determined that the formation of the three-dimensional formed article 200 is completed, and the three-dimensional formation is finished. However, in the case where it is determined as n<N, as shown in FIG. 20 which is a cross-sectional view showing a method for forming the partially formed article 202 of a second layer as a second single layer, the stacking start step (S200) is performed again. At this time, the stage 20 is moved in the Z-axis direction so as to be spaced apart from the ejection port 71c and the laser irradiation parts 81a and 81b by a distance corresponding to the thickness h1 of the partially formed article 201 of the first layer. Further, the stage 20 provided with the plate 21 is moved so that the material flying body 91 which is the sintering material in the form of a droplet ejected from the ejection port 71c of the ejection nozzle 71b of the material ejection part 71 lands at a coordinate position p21 (x21, y21) of the stage 20, which is the starting point of formation of the second layer based on the three-dimensional forming data, and the formation of the second layer of the three-dimensional formed article is started, and then, the step is shifted to the single layer formation step (S300) for the second layer.

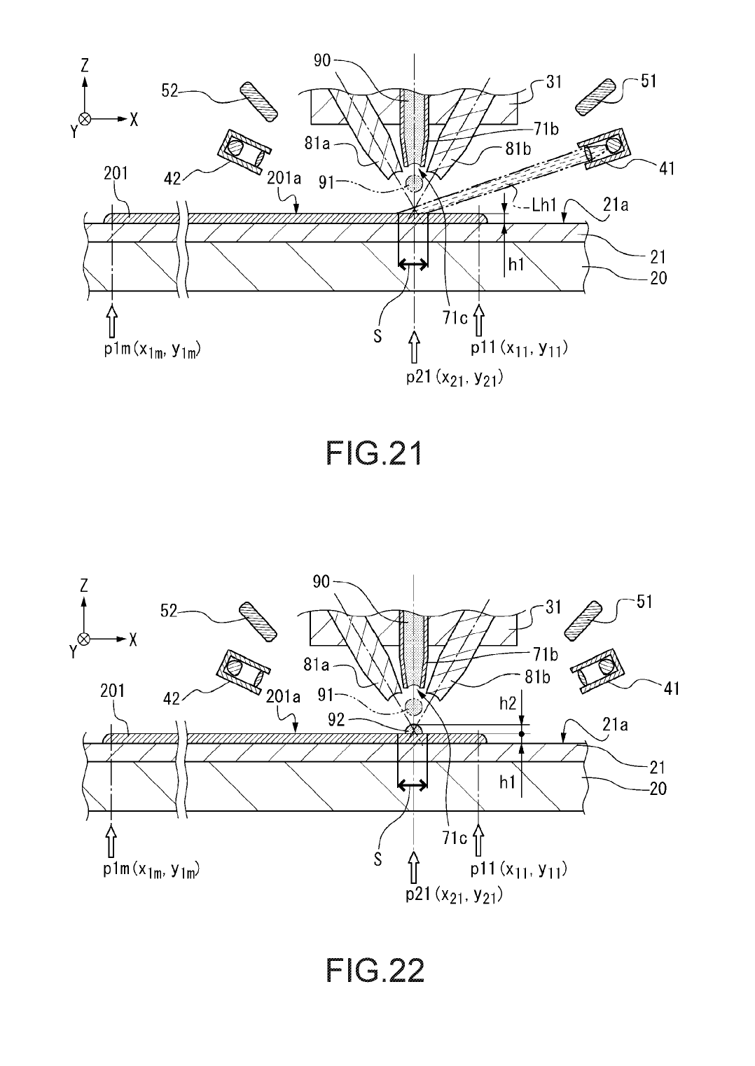

Thereafter, in the same manner as in FIGS. 9 to 19 showing the formation of the partially formed article 201 of the first layer described above, the single layer formation step (S300) is performed. First, as the heating step (S310), as shown in FIG. 21, the plate 21 is moved accompanying the movement of the stage 20 so that the ejection nozzle 71b held by the head 31 faces the plate 21 at the position p21 (x21, y21) as the predetermined position in the stacking start step (S200), and the supply material 90 introduced into the ejection nozzle 71b is ejected from the ejection port 71c and flies toward the upper surface 201a of the partially formed article 201 as the material flying body 91, and the material supply region S in which the material lands on the upper surface 201a is heated by the heat beam Lh1 radiated from the first lamp 41.

After the material supply region S on the upper surface 201a of the partially formed article 201 on which the material flying body 91 is landed is heated to the predetermined temperature in the heating step (S310), the step is shifted to the material supply step (S320). In the material supply step (S320), as shown in FIG. 22, the plate 21 is moved so that the ejection nozzle 71b held by the head 31 faces the plate 21 at the position p21 (x21, y21) as the predetermined position in the stacking start step (S200), and the supply material 90 as the sintering material is ejected in the gravity direction from the ejection nozzle 71b through the ejection port 71c as the material flying body 91 in the form of a droplet toward the plate 21.

The material flying body 91 lands on the upper surface 201a of the partially formed article 201 and is formed at the position p21 (x21, y21) on the upper surface 201a as a unit material 92. The unit material 92 formed on the upper surface 201a is constituted by the undried part 92a which is not dried and the dry part 92b which is formed by evaporating the liquid component such as the solvent or dispersion medium contained in the supply material 90 in the vicinity of the upper surface 201a by the heat of the material supply region S of the partially formed article 201 as having been described with reference to FIG. 12.

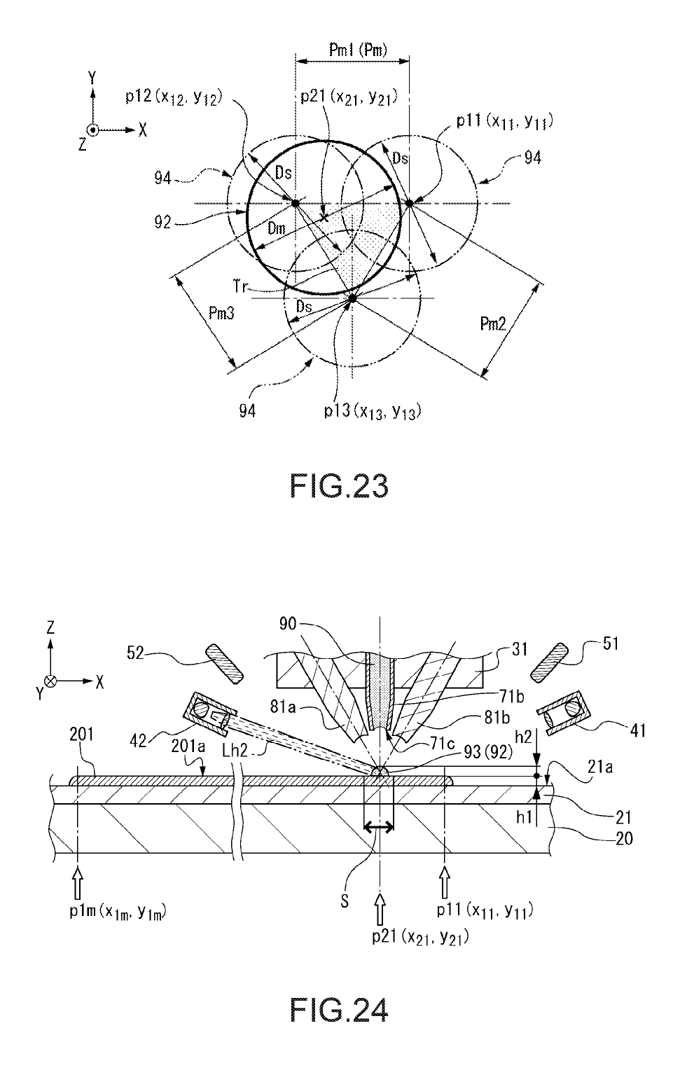

The material flying body 91 lands on the upper surface 201a of the partially formed article 201 and is placed on the upper surface 201a as the unit material 92, and the material supply step (S320) at the position p21 (x21, y21) is finished, whereby the unit material 92 having a height of h2 (so-called “overlay amount”) is formed on the upper surface 201a of the partially formed article 201. This unit material 92 placed on the partially formed article 201 is placed as shown in FIG. 23.

FIG. 23 is a conceptual plan view for conceptually explaining the configuration of the placement and formation by illustrating the state where the unit material 92 which constitutes a partially formed article 202 of the second layer at the position p21 (x21, y21) where the unit material 92 should be landed on the upper surface 201a of the partially formed article 201 shown in FIG. 22 is landed on three sintered bodies 94 at the forming positions p11 (x11, y11), p12 (x12, y12), and p13 (x13, y13) which constitute part of the partially formed article 201 as the lower layer and are adjacent to one another. Incidentally, for the sake of convenience of explanation, the sintered bodies 94 which constitute the partially formed article 201 of the first layer are drawn by an alternate long and two short dashes line, and the unit material 92 which forms the partially formed article 202 of the second layer is drawn by a solid line. Further, the forming position coordinates p11 (x11, y11), p12 (x12, y12), and p13 (x13, y13) of the sintered bodies 94 included in the partially formed article 201 are indicated by “”, and the forming position coordinate p21 (x21, y21) of the unit material 92 which forms the partially formed article 202 is indicated by “X”.

As shown in FIG. 23, the forming position p21 (x21, y21) of the unit material 92 which constitutes the partially formed article 202 of the second layer is placed such that the unit material 92 overlaps with a triangular region Tr (a shaded hatched part) obtained by connecting the forming positions p11 (x11, y11), p12 (x12, y12), and p13 (x13, y13) of the sintered bodies 94 which constitute part of the partially formed article 201 as the lower layer and are adjacent to one another. At this time, the respective distances Pm1, Pm2, and Pm3 between the forming positions p11 (x11, y11), p12 (x12, y12), and p13 (x13, y13) of the sintered bodies 94 adjacent to one another and the sintering diameter Ds of the sintered body 94 satisfy the following conditions: Pm1<Ds, Pm2<Ds, and Pm3<Ds.

By placing the unit material 92 which constitutes the partially formed article 202 of the second layer in this manner, even if an unoverlapped part is generated by the sintered bodies 94 formed at the forming positions p11 (x11, y11), p12 (x12, y12), and p13 (x13, y13) and adjacent to one another in the partially formed article 201 of the first layer, the unit material 92 which forms the partially formed article 202 of the second layer is formed overlapped with the upper layer, and therefore, the occurrence of a defective part such as an internal gap generated by the unformed part inside the three-dimensional formed article 200 can be prevented.

After the unit material 92 is disposed on the upper surface 201a of the partially formed article 201, the step is shifted to the drying step (S330). In the drying step (S330), as shown in FIG. 24, the heat beam Lh2 is irradiated from the second lamp 42 to the unit material 92 landed on the upper surface 201a of the partially formed article 201 in the material supply step (S320). At this time, the temperature of the unit material 92 is measured by the second thermometer 52, and an electric power to be input to the second lamp 42 is controlled, and the energy of the heat beam Lh2 to provide a predetermined drying temperature is irradiated to the unit material 92. Then, the liquid component is evaporated and dried, and a unit material 93 after drying is formed, and thus, the unit material 93 can ensure the height h2 (so-called “overlay amount”) from the upper surface 201a of the partially formed article 201.

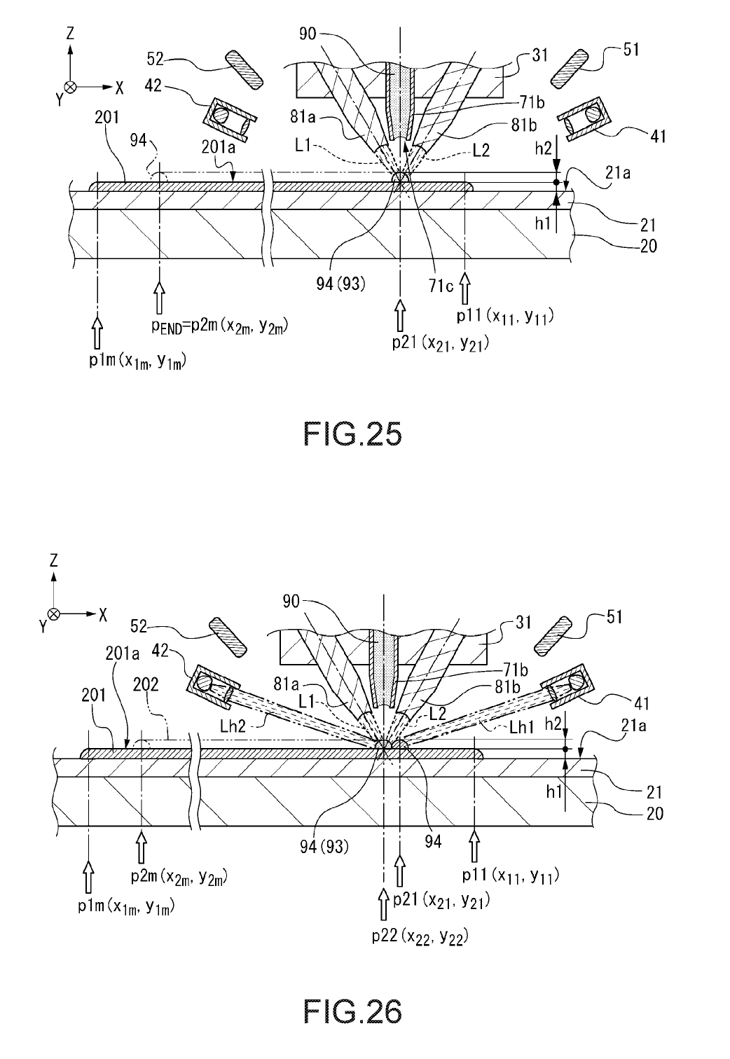

After the unit material 93 is disposed on the upper surface 201a through the drying step (S330), the sintering step (S340) is started. In the sintering step (S340), as shown in FIG. 25, the lasers L1 and L2 are irradiated to the unit material 93 after drying from the laser irradiation parts 81a and 81b. By the energy (heat) of the lasers L1 and L2, the unit material 93 is sintered, whereby a sintered body 94 is formed. Then, the heating step (S310), the material supply step (S320), the drying step (S330), and the sintering step (S340) are repeated, whereby the partially formed article 202 of the second layer is formed on the upper surface 201a of the partially formed article 201 of the first layer. The partially formed article 202 is formed by repeating the heating step (S310), the material supply step (S320), the drying step (S330), and the sintering step (S340) m times along with the movement of the stage 20, and the m-th sintered body 94 is formed at a coordinate position pEND=p2m (x2m, y2m) of the stage 20, which becomes an edge portion of the partially formed article 202.

After the sintered body 94 is formed at the position p21 (x21, y21), the formation path confirmation step (S350) in which it is determined whether or not the number of repetitions of the heating step (S310), the material supply step (S320), the drying step (S330), and the sintering step (S340) has reached m times until the partially formed article 202 of the second layer is formed, that is, whether or not the ejection nozzle 71b has reached the coordinate position pEND=p2m (x2m, y2m) of the stage 20 is performed. In the formation path confirmation step (S350), in the case where it is determined that the number of repetitions has not reached m times, that is, the ejection nozzle 71b has not reached the coordinate position pEND=p2m (x2m, y2m) of the stage 20 so that it is determined as “NO”, as shown in FIG. 26, the step is shifted to the heating step (S310) again, and the stage 20 is driven so that the ejection nozzle 71b faces the stage 20 at a position p22 (x22, y22) which is the forming position of the subsequent unit material 92. Then, after the ejection nozzle 71b faces the stage 20 at the position p22 (x22, y22), the heating step (S310), the material supply step (S320), the drying step (S330), and the sintering step (S340) are performed, and thus, the sintered body 94 is formed at the position p22 (x22, y22).

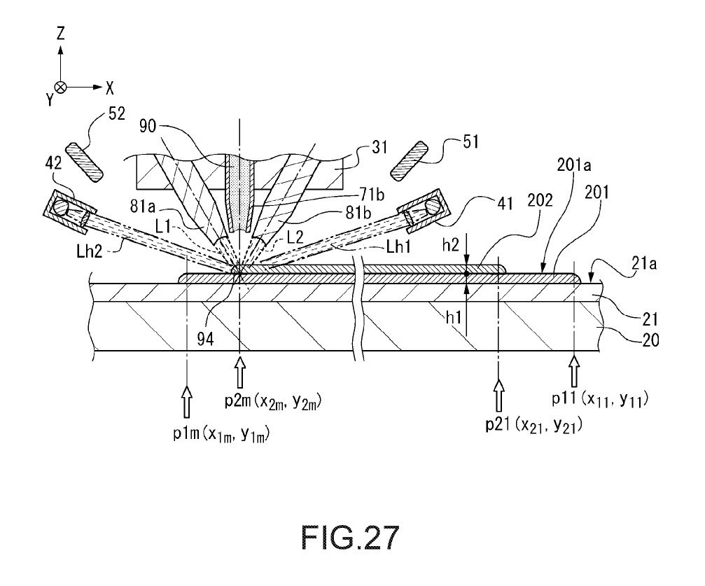

Then, as shown in FIG. 27, by repeating the heating step (S310), the material supply step (S320), the drying step (S330), and the sintering step (S340) m times, the partially formed article 202 of the second layer is formed. Then, when it is confirmed whether or not the coordinate position of the stage 20 that the ejection nozzle 71b faces at the m-th repetition is located at the coordinate position pEND=p2m (x2m, y2m) of the stage 20 and it is determined as “YES”, the single layer formation step (S300) for the second layer is finished. Incidentally, also in the case where the partially formed article 202 of the second layer is formed, as having been described with reference to FIGS. 17 and 18, the unit material 92 is placed on the upper surface 201a of the partially formed article 201 such that the formula (1) or the formula (2) is satisfied.

Then, the step is shifted to the stacked layer number comparison step (S400) again, and the stacking start step (S200) and the single layer formation step (S300) are repeated until n=N, whereby the three-dimensional formed article 200 can be formed using the three-dimensional forming device 1000 according to the first embodiment. Incidentally, a process of performing the stacking start step (S200) and the single layer formation step (S300) of forming the partially formed article 202 of the second layer as the second single layer on the partially formed article 201 of the first layer as the first single layer is referred to as “stacking step” in the application example and the stacking step is repeated until it is determined as n=N in the stacked layer number comparison step (S400).

### Third Embodiment

As a third embodiment, the three-dimensional formed article 200 obtained by the three-dimensional forming method according to the second embodiment using the three-dimensional forming device 1000 according to the first embodiment will be described. Incidentally, the “three-dimensional formed article” as used herein refers to an article formed as a so-called “three-dimensional shaped article”, and for example, even if it is a formed article having a plate shape or a so-called two-dimensional shape, it is included in the three-dimensional formed article as long as it has a shape with a thickness.

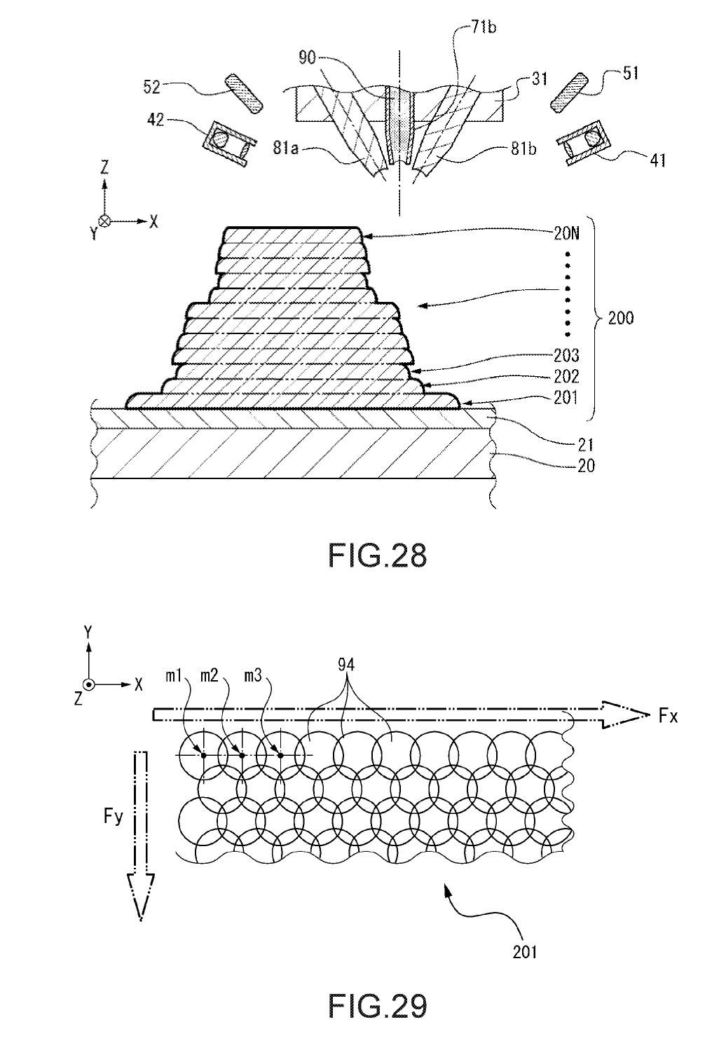

FIG. 28 is a cross-sectional view schematically showing the three-dimensional formed article 200 according to the third embodiment formed on the plate 21 of the three-dimensional forming device 1000. Incidentally, the shape and configuration of the three-dimensional formed article 200 shown in FIG. 28 are not particularly limited, and in this example, for the sake of convenience of explanation, a configuration in which a rectangular plate (not shown) is stacked is adopted. Then, as shown in FIG. 28, the three-dimensional formed article 200 is formed by stacking partially formed articles 201, 202, 203, . . . , up to 20N by relatively driving the stage 20, and at least the head 31 including the ejection nozzle 71b included in the material ejection part 71, and the laser irradiation parts 81a and 81b, and the lamps 41 and 42 in the X, Y, and Z directions. A configuration of forming the respective partially formed articles will be described by showing, for example, the partially formed article 201 as an example.

A scanning configuration of the head 31 will be described as an example. As shown in FIG. 29, in the three-dimensional formed article 200 according to this embodiment, the respective partially formed articles are formed such that a unit material 93 is formed on a plate 21 by ejecting a material from the material ejection part 71 while moving the head 31 in the direction of the arrow Fx shown in the drawing, followed by irradiation with the lasers L1 and L2, whereby sintered bodies 94 are sequentially formed at the forming positions m1, m2, and m3 shown in the drawing in this order (see FIGS. 15 and 16), and when the formation of the sintered bodies 94 in predetermined regions in the Fx direction is finished, the head 31 is moved in the Fy direction, and sintered bodies 94 are formed in predetermined regions in the Fx direction. By performing scanning with the head 31 in this manner, the partially formed article 201 as a sintered single layer of an assembly of the sintered bodies 94 is formed.

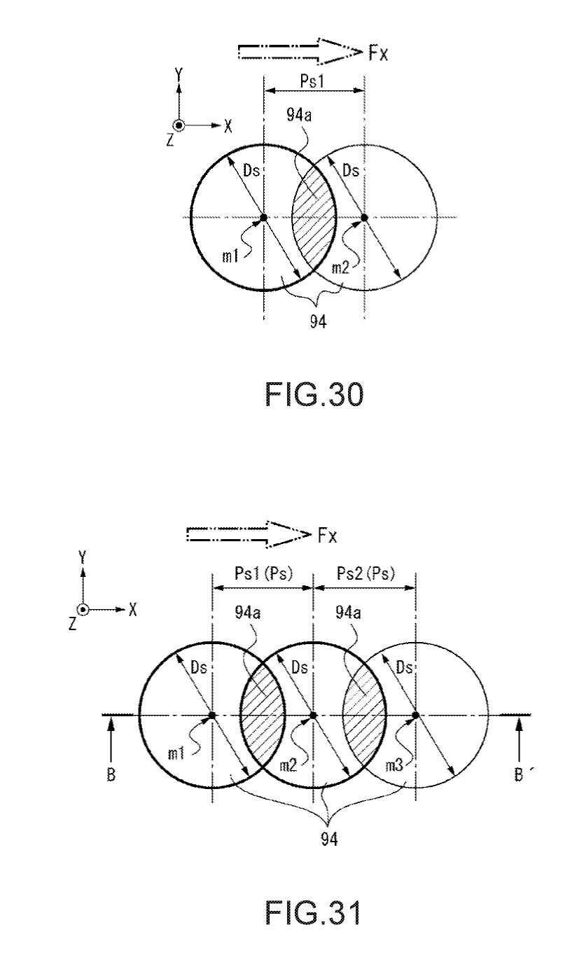

The sintered bodies 94 formed by scanning with the head 31 shown in FIG. 29 are placed as shown in FIGS. 30 and 31. As shown in FIG. 30, the sintered body 94 is formed at the forming position m2 so as to be adjacent to the sintered body 94 formed at the forming position m1. The sintered body 94 at the forming position m1 and the sintered body 94 at the forming position m2 are formed at a distance of Ps1 corresponding to the distance of Pm as having been described with reference to FIG. 17, that is, at a dot pitch Ps1.

The dot pitch Psi is set such that an overlapped part 94a is formed so that an unformed part of the sintered body 94 is not generated between the sintered body 94 at the forming position m1 and the sintered body 94 at the forming position m2. That is, it is preferred that the sintered bodies 94 are placed such that Ps1 with respect to the forming diameter of the sintered body 94, that is, the sintered body diameter Ds satisfies the following condition: Ps1<Ds.

FIG. 31 shows the placement of a sintered body 94 formed at the forming position m3 adjacent to the forming position m2 shown in FIG. 30. The sintered body 94 at the forming position m2 and the sintered body 94 at the forming position m3 are formed at a distance of Ps2. Hereinafter, the distance of Ps2 is referred to as “dot pitch Ps2”. The dot pitch Ps2 is set such that an overlapped part 94a is formed so that an unformed part of the sintered body 94 is not generated between the sintered body 94 at the forming position m2 and the sintered body 94 at the forming position m3. That is, it is preferred that the sintered bodies 94 are placed such that Ps2 with respect to the forming diameter Ds of the sintered body 94 satisfies the following condition: Ps2<Ds.

In this manner, it is preferred that the scanning with the head 31 is controlled such that the sintered bodies 94 formed in the scanning direction Fx shown in FIG. 31 are placed such that when each of the dot pitches Ps1 and Ps2 of the adjacent sintered bodies 94 is referred to as “dot pitch Ps”, the following condition is satisfied: Ps<Ds. Further, in order to expand the sintered region formed by the adjacent sintered bodies 94, it is preferred to satisfy the following condition: Ps≧Ds/2. That is, it is more preferred to satisfy the following condition: 0.5≦Ps/Ds<1.0.

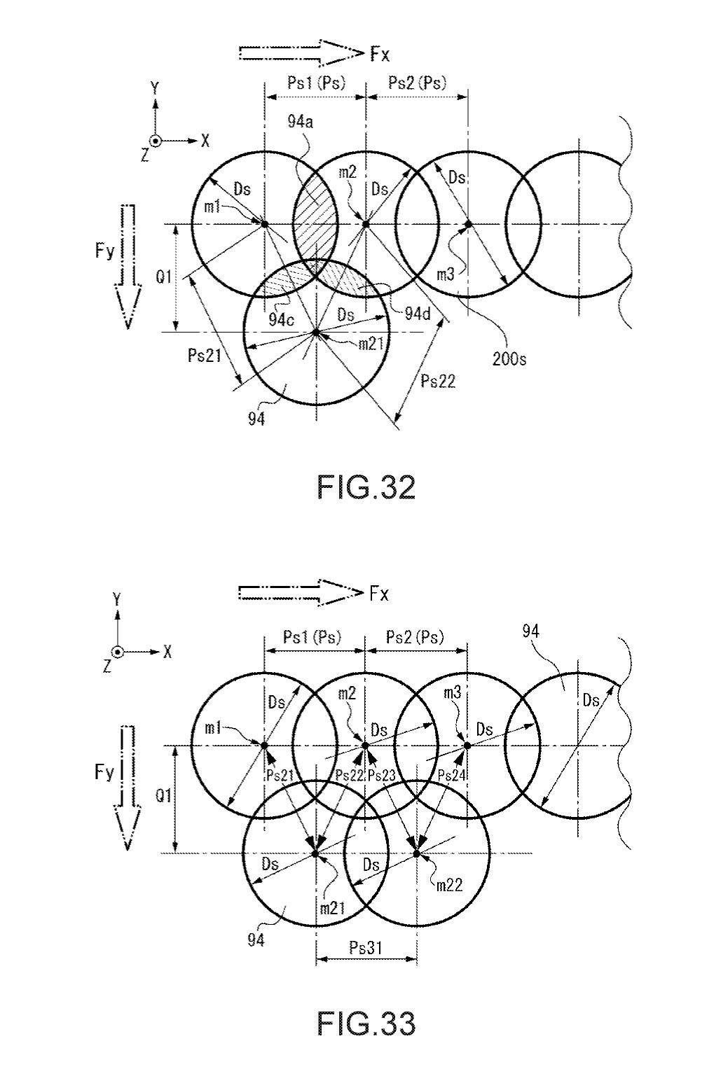

FIGS. 32 and 33 are conceptual views illustrating the placement of sintered bodies when forming sintered bodies 94 in the second row by moving the head 31 by a line pitch Q1 along the scanning direction Fy with respect to the sintered bodies 94 in the first row formed along the scanning direction Fx shown in FIGS. 30 and 31.

As shown in FIG. 32, a dot pitch Ps21 which is the distance between the centers of the sintered body 94 formed at the forming position m1 in the first row and the sintered body 94 formed at the forming position m21 in the second row adjacent to the sintered body 94 formed at the forming position m1 in the first row satisfies the following condition: Ps21<Ds, and preferably satisfies the following condition: Ps21≧Ds/2, that is, the following condition is preferably satisfied: 0.5≦Ps21/Ds<1.0 in the same manner as the relationship between the adjacent sintered bodies 94 in the first row described above.

Further, a dot pitch Ps22 which is the distance between the centers of the sintered body 94 formed at the forming position m2 adjacent to the forming position m1 in the first row and the sintered body 94 formed at the forming position m21 in the second row adjacent to the sintered body 94 formed at the forming position m2 in the first row satisfies the following condition: Ps22<Ds, and preferably satisfies the following condition: Ps22≧Ds/2, that is, the following condition is preferably satisfied: 0.5≦Ps22/Ds<1.0 in the same manner as the relationship between the adjacent sintered bodies in the first row described above.

As described above, when each of the dot pitches Ps1, Ps21, and Ps22 of the sintered bodies 94 formed at the forming positions m1, m2, and m21, that is, the sintered bodies 94 adjacent to one another is referred to as “dot pitch Ps” as the distance between the sintered body centers of the adjacent sintered bodies 94, the following condition is satisfied: Ps<Ds, and the following condition is preferably satisfied: Ps≧Ds/2, that is, the following condition is preferably satisfied: 0.5≦Ps/Ds<1.0. By satisfying such relationships, the sintered bodies 94 with the centers at the forming positions m1, m2, and m21 are overlapped with one another and can have overlapped portions 94a, 94c, and 94d.

FIG. 33 shows a configuration in which a sintered body 94 is formed at the forming position m22 so as to be adjacent to the sintered body 94 formed at the forming position m21 in the second row. As shown in FIG. 33, the sintered body 94 formed at the forming position m22 is formed at a position adjacent to the sintered bodies 94 formed at the forming position m2 and the forming position m21. Further, the sintered body 94 formed at the forming position m22 is formed at a position adjacent to the sintered bodies 94 formed at the forming position m2 and the forming position m3.

When the distance between the centers of the forming position m22 and the forming position m2 is referred to as “dot pitch Ps 23”, the distance between the centers of the forming position m3 and the forming position m22 is referred to as “dot pitch Ps 24”, and the distance between the centers of the forming position m21 and the forming position m22 is referred to as “dot pitch Ps 31”, the respective relationships satisfy the above-mentioned relationships, respectively. That is, the following relationships are satisfied: 0.5≦Ps23/Ds<1.0, 0.5≦Ps24/Ds<1.0, and 0.5≦Ps31/Ds<1.0. When each of the dot pitches Ps23, Ps24, and Ps31 of the sintered bodies 94 adjacent to one another is referred to as “dot pitch Ps” as the distance between the centers of the adjacent sintered bodies 94, the following relationship is satisfied: 0.5≦Ps/Ds<1.0.

The partially formed article 201 as a sintered single layer of an assembly can be obtained by forming sintered bodies while satisfying the above-mentioned dot pitch relationships. In the thus obtained partially formed article 201, by bringing the dot pitch Ps closer to the diameter Ds of the sintered body 94, that is, by bringing the value of Ps/Ds close to 1.0 while satisfying the following relationship: 0.5≦Ps/Ds<1.0, the partially formed article 201 can be formed in a short time, and thus, the productivity can be increased. Further, by bringing the value of Ps/Ds close to 0.5, the partially formed article 201 as a sintered single layer in which the adjacent sintered bodies 94 are densely assembled can be formed, and thus, precise formation can be achieved.

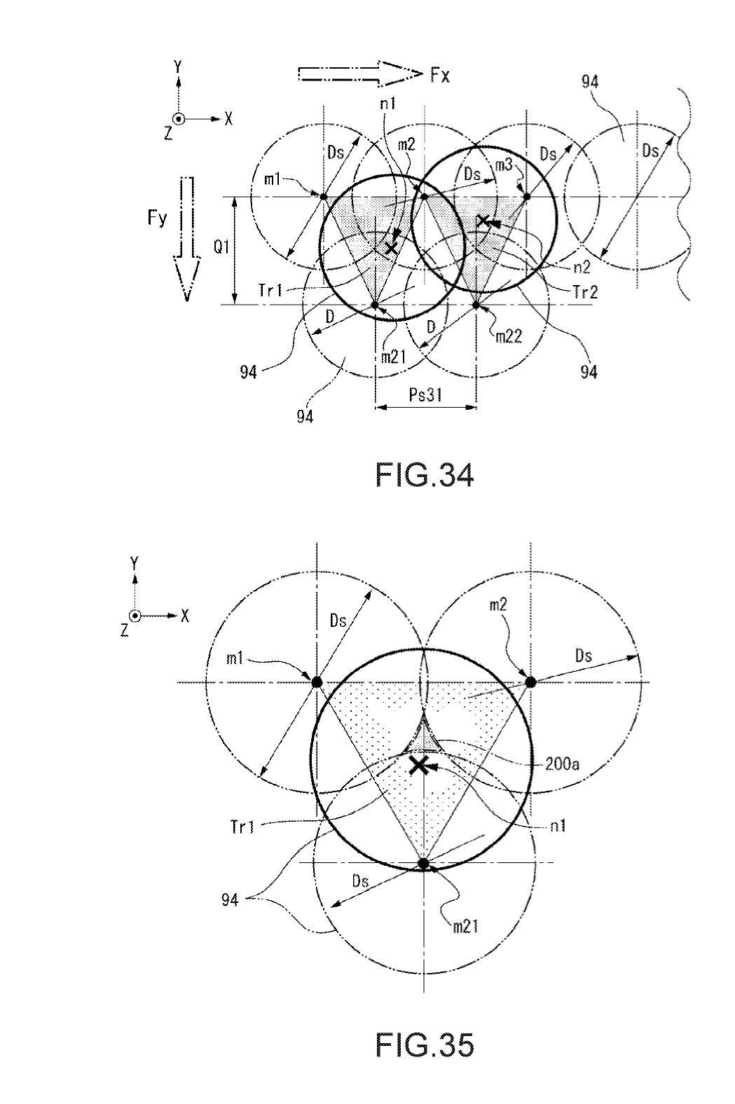

A configuration of forming the sintered body 94 in the case where the partially formed article 202 as the second single layer is stacked on the partially formed article 201 as the first single layer described above is shown in FIGS. 34 and 35. Incidentally, in FIG. 35, for the sake of convenience of explanation, the partially formed article 201 as the first single layer is drawn by an alternate long and two short dashes line, and the partially formed article 202 as the second single layer is drawn by a solid line. Further, the center of the forming position of the sintered body 94 included in the partially formed article 201 is indicated by “”, and the center of the forming position of the sintered body 94 included in the partially formed article 202 is indicated by “X”.

In the case where the partially formed article 202 as the second single layer shown in FIGS. 34 and 35 is formed, the sintered bodies 94 are placed as follows with respect to the partially formed article 201 as the first single layer as having been described with reference to FIGS. 31, 32, and 33. FIG. 34 illustrates two sintered bodies 94 at the forming position n1 and the forming position n2 as part of the sintered bodies 94 included in the partially formed article 202 as the second single layer.

As shown in FIG. 34, the sintered body 94 formed at the forming position n1 included in the partially formed article 202 as the second single layer is placed such that the forming position n1 overlaps in a region in plan view of a triangular region Tr1 obtained by connecting the forming position m1 of the sintered body 94 formed at the forming position m1 as the first sintered body, the forming position m2 of the sintered body 94 formed at the forming position m2 as the second sintered body, and the forming position m21 of the sintered body 94 formed at the forming position m21 as the third sintered body of the partially formed article 201 as the lower layer.

Similarly, the sintered body 94 formed at the forming position n2 is placed such that the forming position n2 overlaps in a region in plan view of a triangular region Tr2 obtained by connecting the forming position m2, the forming position m3, and the forming position m22 of the sintered bodies 94 of the partially formed article 201 as the lower layer.

Further, the forming position n1, the forming position n2, and the sintered bodies 94 (not shown) included in the partially formed article 202 (not shown) are preferably such that the sintered bodies 94 are placed so that the distance between the centers of the forming positions, that is, the dot pitch Ps as the distance between the centers of the adjacent sintered bodies 94 satisfies the following relationship: 0.5≦Ps/Ds<1.0 simultaneously in the same manner as the partially formed article 201.

In this manner, when the sintered bodies 94 formed in the partially formed article 202 as the second single layer are placed such that, for example, as shown in FIG. 35, the respective dot pitches Ps of the adjacent sintered bodies 94 in the partially formed article 201 as the first single layer, in this example, the sintered bodies 94 formed at the forming positions m1, m2, and m21 are close to the value of the diameter Ds of the sintered body 94, a sintered body unformed part 200a may remain between the adjacent sintered bodies 94. However, as shown in FIG. 34 described above, when the sintered body 94 formed at the forming position n1 included in the partially formed article 202 is disposed such that the forming position n1 overlaps in a region in plan view of a triangular region Tr1 obtained by connecting the forming position m1, the forming position m2, and the forming position m21 of the sintered bodies 94 included in the partially formed article 201 as the lower layer, and as shown in FIG. 35, the sintered body 94 is formed at the forming position n1, the sintered body 94 of the partially formed article 202 is formed so as to fill the sintered body unformed part 200a. According to this, the three-dimensional formed article can be obtained while filling an unformed part in the sintered body, in other words, a region which can become a defective part inside the three-dimensional formed article.

After stacking the partially formed article 202 as the second single layer on the partially formed article 201 as the first single layer described above, the partially formed article 202 formed as the second single layer is used as a new first single layer, and a partially formed article 203 as a second single layer is formed on the partially formed article 202 as the first single layer. In this manner, by repeating the stacking of a second single layer on a new first single layer and sequentially forming single layers, the three-dimensional formed article 200 can be obtained.

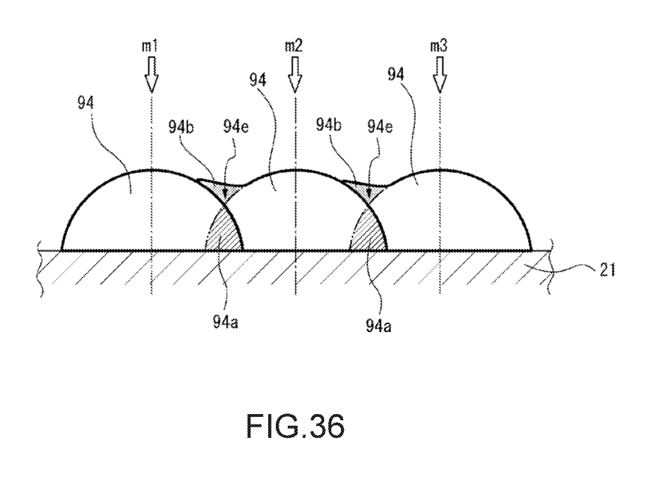

As having been described with reference to FIGS. 30, 31, and 32, by placing the sintered bodies 94 such that the dot pitch Ps and the forming diameter Ds of the sintered body 94 satisfy the following relationship: 0.5≦Ps/Ds<1.0, an overlapped part 94a (a shaded hatched part in the drawing) is generated between the adjacent sintered bodies 94 as shown in FIG. 36 which is a cross-sectional view taken along the line B-B′ in FIG. 31.

When the unit material 92 (see FIG. 11) is supplied at the forming position m2 adjacent to the sintered body 94 formed at the forming position m1, part of the unit material 92 to be supplied at the forming position m2 corresponding to the overlapped part 94a forms a ride-on part 94b which rides on the sintered body 94 formed at the forming position m1, and the sintered body 94 at the forming position m2 is formed so as to fill a cavity 94e formed by the adjacent sintered bodies 94 with the ride-on part 94b.

Further, also in the case of the sintered body 94 formed at the forming position m3, in the same manner as described above, the sintered body 94 is formed at the forming position m3 so as to fill the cavity 94e formed by the sintered bodies 94 formed at the forming position m2 and the forming position m3 with the ride-on part 94b. In this manner, by filling the cavity 94e with the ride-on part 94b, the upper surface of the partially formed article 201 which is an assembly of the sintered bodies 94 can be made smoother.

As described above, by forming and assembling the sintered bodies 94, and stacking the partially formed articles 201, 202, 203, . . . , and 20N as assemblies of the sintered bodies 94, the three-dimensional formed article 200 can be obtained.

The entire disclosure of Japanese patent No. 2015-166484, filed Aug. 26, 2015 is expressly incorporated by reference herein.

What is claimed is:

1. A three-dimensional forming device, which forms a three-dimensional formed article by stacking a layer using a sintering material containing a metal powder, a binder, and a solvent, comprising:
a material supply section which supplies the sintering material to a predetermined material supply region;
a first heating section which heats the predetermined material supply region;
a second heating section which heats the sintering material supplied to the predetermined material supply region from the material supply section; and
an energy irradiation section which supplies energy for sintering the metal powder.

2. The three-dimensional forming device according to claim 1, wherein the material supply section includes an ejection section which ejects the sintering material.

3. The three-dimensional forming device according to claim 1, wherein
the predetermined material supply region is a stage, a metal plate, or the layer which is previously formed,
the first heating section heats the material supply region to a predetermined temperature before the sintering material is supplied to the material supply region, and
the second heating section heats the sintering material supplied to the material supply region to a predetermined temperature.

4. The three-dimensional forming device according to claim 1, wherein the device includes:
a first temperature detection section which detects the temperature of the material supply region to be heated by the first heating section; and
a second temperature detection section which detects the temperature of the sintering material to be heated by the second heating section.

5. A three-dimensional forming method for forming a three-dimensional formed article by stacking a layer using a sintering material containing a metal powder and a binder, comprising:
a material supply step of ejecting the sintering material in the form of a droplet on a first single layer, thereby stacking a unit droplet material;
a heating step of heating a material supply region of the unit droplet material on the first single layer;
a drying step of drying a unit material formed by the unit droplet material landed on the first single layer, thereby forming a dry sintering material;
a sintering step of sintering the dry sintering material by supplying energy for sintering the dry sintering material to the dry sintering material, thereby forming a sintered body;
a single layer formation step of forming a sintered single layer by assembling the sintered bodies; and
a stacking step of stacking the sintered single layer as the first single layer on the first single layer and forming a second single layer by the single layer formation step, wherein
the heating step is performed before the material supply step.

6. The three-dimensional forming method according to claim 5, wherein when a unit material diameter in plan view of the unit material is represented by Dm and a distance between the unit material centers of the unit materials adjacent to each other is represented by Pm, the following relationship is satisfied: 0.5≦Pm/Dm<1.0.

7. The three-dimensional forming method according to claim 6, wherein
the sintered single layer includes a first sintered body, a second sintered body, and a third sintered body, which are adjacent to one another, and
in the second single layer, the unit material center of the unit material forming the sintered body included in the second single layer overlaps with a triangular region in plan view formed by connecting the respective sintered body centers of the first sintered body, the second sintered body, and the third sintered body included in the first single layer.

8. A three-dimensional formed article, which is obtained by stacking, on a first single layer including a sintered single layer obtained by stacking a layer using a sintering material containing a metal powder and a binder, and irradiating an energy beam for sintering the sintering material, a second single layer including at least the sintered single layer, wherein
the sintered single layer is formed by assembling sintered bodies obtained by sintering by irradiating the sintering material ejected in the form of a droplet with the energy beam, and
when a sintered body diameter in plan view of the sintered body is represented by Ds and a distance between the sintered body centers of the sintered bodies adjacent to each other is represented by Ps, the following relationship is satisfied: 0.5≦Ps/Ds<1.0.

9. The three-dimensional formed article according to claim 8, wherein
the sintered single layer includes a first sintered body, a second sintered body, and a third sintered body, which are adjacent to one another, and
the second single layer is placed such that the sintered body center of the sintered body included in the second single layer overlaps with a triangular region in plan view formed by connecting the respective sintered body centers of the first sintered body, the second sintered body, and the third sintered body included in the first single layer.
